(19) United States
(12) Patent Application Publication
(10) Pub. No.: US 2026/0289133 A1
(43) Pub. Date: Sep. 24, 2026

(54) SYSTEM

(71) Applicant: SoftBank Group Corp., Tokyo (JP)

(72) Inventor: Hiroyuki YAMAUCHI, Tokyo (JP)

(73) Assignee: SoftBank Group Corp., Tokyo (JP)

(21) Appl. No.: 19/561,613

(22) Filed: Mar. 10, 2026

(30) Foreign Application Priority Data
Mar. 19, 2025 (JP) 2025-045005

(51) Int. Cl. G06F 40/30; G06F 40/284; G06F 40/295; G06F 40/40; G06N 3/0475

(52) U.S. Cl. CPC G06F 40/30; G06F 40/284; G06F 40/295; G06F 40/40; G06N 3/0475

(57) ABSTRACT

A system includes a processor that is configured to receive information from a user, analyze the received information by using a generative artificial intelligence means, classify the information into an appropriate department based on a result of the analysis, analyze an emotional state of the user, set a priority of the information based on a result of the emotional state analysis, perform attendance management based on declarations submitted by the user, calculate a total overtime working time, issue a warning when the total overtime working time exceeds a predetermined time, and check, based on a remark input by the user, a reason for leaving during working hours and a presence or absence of a meal.

### CROSS-REFERENCE TO RELATED APPLICATION

This application is based on and claims priority under 35 USC 119 from Japanese Patent Application No. 2025-045005 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information management and attendance management systems require users to manually classify submitted information to appropriate departments, manually set priorities, and separately manage attendance and overtime. Such systems do not employ generative artificial intelligence to interpret the content of user-submitted information, and therefore cannot flexibly classify diverse and ambiguous inputs. Further, conventional systems generally do not analyze the emotional state of the user, and thus cannot adjust the priority of information based on urgency implied by the user's emotional condition. As a result, important or urgent matters may be processed with low priority, and organizational responsiveness may be degraded. In addition, in conventional attendance systems based on declared working hours, the calculation of overtime and the issuance of warnings when overtime exceeds a certain threshold are often handled by separate tools or manual operations, which increases the risk of human error and delays. Moreover, conventional systems rarely utilize detailed remark inputs, such as reasons for leaving during working hours or presence or absence of a meal, to accurately grasp the user's actual attendance situation. Consequently, it is difficult to prevent unnecessary overtime and unpaid work and to properly understand work conditions. Therefore, there is a need for a system that receives information from users, automatically analyzes the information content by generative artificial intelligence, classifies the information to appropriate departments, analyzes the user's emotional state to dynamically set priorities, and, in an integrated manner, performs declaration-based attendance management including overtime calculation, threshold-based warnings, and detailed confirmation of remarks such as reasons for leaving and meal status, so as to accurately grasp attendance status and improve operational efficiency.

### SUMMARY

In order to solve the above-described problems, an embodiment of the present invention provides a system comprising a processor, wherein the processor is configured to receive information from a user and analyze the received information by using a generative artificial intelligence means. Based on a result of this analysis, the processor classifies the information into an appropriate department, thereby automatically routing diverse and ambiguous user inputs without requiring manual classification. Furthermore, the processor analyzes an emotional state of the user and sets a priority of the information based on a result of the emotional state analysis, so that information submitted under a high-stress or urgent emotional condition can be processed with higher priority. The processor is also configured to perform attendance management based on declarations submitted by the user, to calculate a total overtime working time for the user, and to issue a warning when the total overtime working time exceeds a predetermined time. The processor may issue the warning directly to the user when the predetermined time is exceeded. In addition, the processor is configured to check, based on a remark input by the user, a reason for leaving during working hours and a presence or absence of a meal, and to thereby further accurately grasp an attendance status of the user. By integrating generative artificial intelligence analysis, emotional state analysis, information classification, dynamic priority setting, declaration-based attendance management, overtime calculation and threshold-based warnings, and detailed remark-based confirmation of leaving reasons and meal status into a single system, the invention enables automated, accurate, and comprehensive management of both information handling and user attendance.

The term “system” refers to an integrated combination of hardware, software, and communication components that cooperatively execute the processing defined in the claims.

The term “processor” refers to one or more hardware processing units, such as a CPU, GPU, or dedicated logic circuitry, and may include associated memory and control logic configured to execute instructions for performing the claimed functions.

The term “user” refers to an individual, such as an employee or staff member, who inputs information, including general information and attendance-related declarations, into the system.

The term “information” refers to data submitted by the user to the system, including but not limited to textual messages, inquiries, requests, and attendance-related inputs such as working hours and remarks.

The term “generative artificial intelligence means” refers to software and associated models that implement a generative artificial intelligence algorithm, such as a large language model or other neural network-based generative model, configured to analyze, interpret, or transform user-submitted information.

The term “analyze the received information” refers to processing the information by the generative artificial intelligence means to extract content features, intent, context, or semantic meaning from the user-submitted information.

The term “appropriate department” refers to a logical or organizational unit within an organization, such as a specific team, division, or role, that is responsible for handling or responding to the user-submitted information.

The term “classify the information” refers to assigning the user-submitted information to one or more appropriate departments based on the analysis result, so that the information is routed or associated with the relevant organizational unit.

The term “emotional state of the user” refers to an estimated psychological condition of the user, such as stress level, urgency, frustration, or satisfaction, inferred from the content, tone, or other characteristics of the user-submitted information.

The term “emotional state analysis” refers to processing performed by the processor to estimate the emotional state of the user from the received information, for example by applying natural language processing or machine learning techniques.

The term “priority of the information” refers to a level or rank that indicates an order or degree of importance, urgency, or processing preference assigned to the user-submitted information.

The term “attendance management based on declarations” refers to managing working status of the user, including working time and break time, on the basis of time and related data explicitly declared or input by the user, rather than solely on automatic time-clock recordings.

The term “overtime working time” refers to a duration of working time that exceeds a predefined standard working time for a given reference period, such as a daily or monthly standard, calculated from the user's declared attendance data.

The term “total overtime working time” refers to a cumulative amount of overtime working time aggregated over a specified period, such as a calendar month, for a particular user.

The term “predetermined time” refers to a threshold time value, such as a fixed number of overtime hours, stored in the system configuration, against which the total overtime working time is compared.

The term “warning” refers to a notification or alert generated by the processor and provided to the user or an administrator to indicate that a condition, such as the total overtime working time exceeding the predetermined time, has been satisfied.

The term “remark input” refers to additional user-inputted text or data fields associated with an attendance record, including descriptions of activities, reasons for leaving, or meal-related information provided by the user.

The term “reason for leaving during working hours” refers to an explanation entered by the user in the remark input that describes the purpose or nature of a temporary absence from the workplace during scheduled working hours or break periods.

The term “presence or absence of a meal” refers to an indication, derived from the remark input or a dedicated flag, specifying whether the user has taken a meal during a working period or break.

The term “attendance status of the user” refers to an overall state of the user's work-related presence, absence, working time, break time, overtime, and related contextual information, as managed and evaluated by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

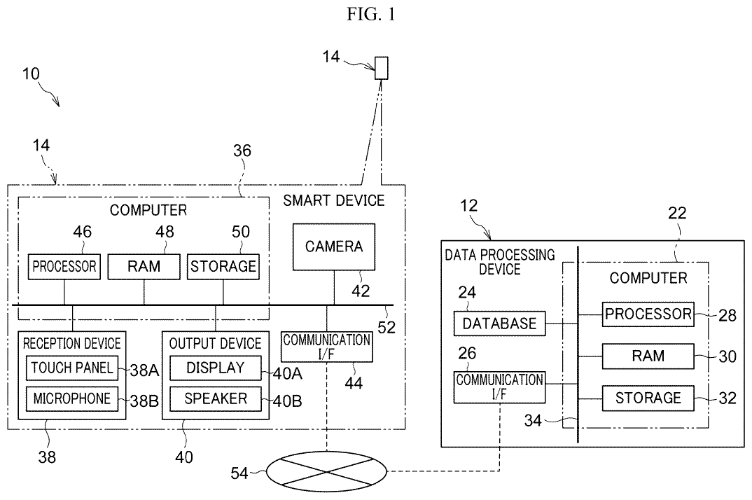

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

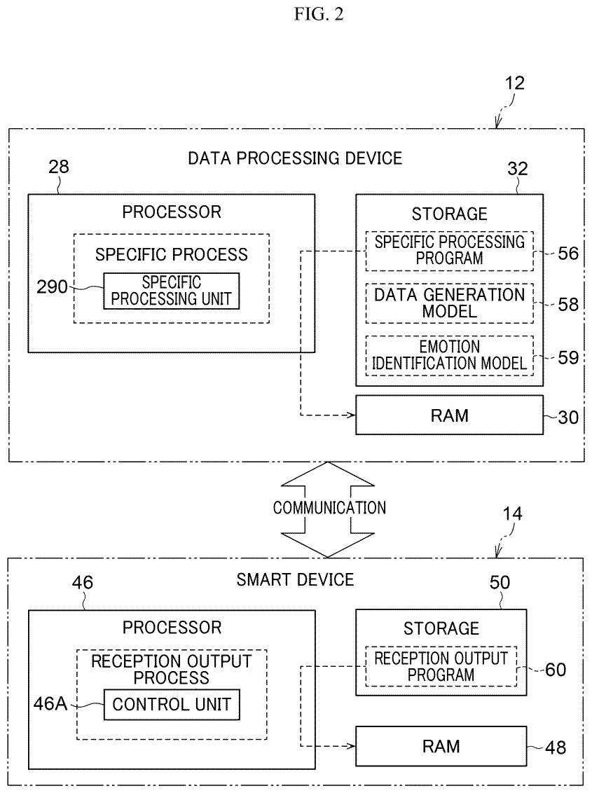

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional attendance management and internal information routing systems typically rely on static rule-based logic and simple form processing executed by generic servers. Such systems suffer from several technical limitations in terms of how computing resources process, classify, and prioritize heterogeneous user inputs over communication networks.

First, a conventional server generally treats user-submitted text, including work reports, inquiries, and attendance remarks, as unstructured strings and applies only predefined keyword rules. As a result, the server cannot flexibly interpret diverse natural language expressions and cannot adapt to variations in user wording. This leads to inefficient data routing within the computing environment, because the server often forwards information to inappropriate processing units, thereby increasing processing load, network traffic, and latency within the system.

Second, conventional systems do not effectively integrate emotional state analysis into the computation pipeline. Even when a large number of requests and attendance reports are received, the server usually processes them in simple chronological or fixed-priority order. The server, therefore, cannot dynamically adjust processing priority based on user sentiment or urgency inferred from text content. This causes a suboptimal allocation of processing resources and delays in handling urgent issues, and increases the overall processing time of the system.

Third, traditional attendance management solutions implemented on servers typically calculate working hours and overtime using only start and end times and a fixed break duration. Such solutions do not accurately handle user-declared intermediate absences or distinguish between different types of break behaviors. Free-text remarks are either ignored or stored without machine-usable structure. Consequently, the computing system maintains attendance records that are logically incomplete or inconsistent with actual work behavior, which degrades the quality of the stored data and causes repeated corrections and reprocessing.

Fourth, existing systems that generate warnings for overtime commonly implement simple threshold checks over aggregated values, without maintaining a structured and queryable history of warning events and their contextual data. This prevents the server from efficiently performing subsequent analyses, audit logging, and optimization of warning rules. The absence of integrated history management forces external components to perform additional, redundant computations to reconstruct the sequence of events.

Fifth, integration of advanced language models into the server's processing logic is often performed in an ad hoc manner, where a generative model is used only for user-facing responses rather than as a core component of back-end classification and structured data enrichment. This results in a separation between the front-end conversational layer and the back-end data processing layer, wasting computational results produced by the model and limiting the improvement in data quality and routing efficiency.

Accordingly, there is a need for a server-based system and processing method that technically improves how a computer processes user information, by: (i) using a generative artificial intelligence model to perform robust semantic and emotional analysis of user inputs; (ii) dynamically classifying and routing information to appropriate processing units; (iii) computing attendance and overtime with higher logical fidelity by algorithmically interpreting free-text remarks; and (iv) automatically recording and surfacing warning histories and structured classifications in a format optimized for machine processing and administrator review. Such a system should enhance the efficiency, accuracy, and reliability of the overall computing environment, rather than merely automating a human workflow.

The specific processing by the specific processing unit 290 of the data processing device 12 in Example 1 is realized by the following means.

The present invention provides a server comprising a processor and a memory storing instructions that, when executed by the processor, cause the server to receive user information from a user terminal via a communication path, analyze the received user information by using a generative artificial intelligence model to generate structured analysis results, classify the user information into internal processing units based on the structured analysis results, analyze an emotional state of a user from the received user information and assign a processing priority to the user information based on an emotion analysis result, provide to the user terminal an operation interface that accepts declaration-based work time information, break time information, and free-text remarks, compute actual work time and aggregate overtime totals for calendar units based on the declared information, compare the overtime totals with at least one stored time threshold and, in response to determining that an overtime total exceeds the time threshold, automatically generate and transmit warning data and store corresponding warning history, perform string analysis on the free-text remarks by using at least one expression set or a trained language model to detect intermediate absence behaviors and eating and drinking behaviors, associate classification information indicating detected behaviors with attendance records stored in a controlled-access data storage device, periodically aggregate attendance records, overtime totals, and warning history into administrator-oriented summary data, and output the summary data to an administrator display screen in a machine-readable and query-efficient format. This enables a technical improvement in the functioning of the computer system by allowing the server to automatically transform heterogeneous natural language inputs into structured, priority-aware, and semantically enriched records, to execute more accurate and efficient overtime computation and warning generation, to reduce misrouting and reprocessing of user information, and to enhance the reliability and auditability of attendance and alert data within the computing infrastructure.

The term “system” refers to an integrated combination of hardware resources, software resources, and communication resources that cooperate to execute the claimed operations.

The term “processor” refers to one or more hardware processing units, such as a central processing unit or a microcontroller, capable of executing machine-readable instructions.

The term “memory” refers to one or more hardware storage media, such as volatile memory or non-volatile memory, that store instructions and data for access by the processor.

The term “instructions” refers to machine-readable commands that, when executed by the processor, cause the processor to perform one or more of the operations described in the claims.

The term “user terminal” refers to an electronic device operated by a user, such as a computing device including a display and an input unit, that can send information to and receive information from the server over a communication path.

The term “communication path” refers to a logical or physical communication channel, such as a wired or wireless network connection, that enables data exchange between the server and one or more user terminals.

The term “user information” refers to data received from a user terminal, including at least work time information, break time information, attendance-related information, remarks, and other text or metadata associated with user activity.

The term “generative artificial intelligence model” refers to a machine-learned model configured to generate or transform content, such as text, based on learned patterns, and to output analysis results including semantic or emotional features from input user information.

The term “structured analysis results” refers to data derived from processing user information by the generative artificial intelligence model, where the data is organized into identifiable fields, labels, or categories suitable for subsequent programmatic processing.

The term “processing unit” refers to a logical or functional subdivision within an organization or within the server's software architecture that is responsible for handling a particular category of user information.

The term “classification” refers to an operation in which user information is assigned to one or more categories, labels, or processing units based on analysis results or predefined criteria.

The term “emotional state” refers to a representation of a user's affective condition, such as stress, urgency, satisfaction, or dissatisfaction, inferred from the content and context of the user information.

The term “processing priority” refers to a relative importance or urgency level assigned to user information, which influences the order, allocation of resources, or conditions under which the information is processed by the system.

The term “operation interface” refers to a graphical or programmatic interface, such as a screen or form provided to a user terminal, that allows a user to input or confirm data including work time information, break time information, and remarks.

The term “declaration-based work time information” refers to work time data that is explicitly input or declared by a user, including at least a work start time and a work end time, rather than being captured solely by automatic sensing.

The term “break time information” refers to data indicating a period or periods during which a user is not performing work, including at least a break start time and a break end time.

The term “remark” refers to free-text information input by a user in association with attendance or work data, describing contextual details such as reasons for breaks, intermediate absences, or other conditions.

The term “actual work time” refers to a duration of time during which a user is considered to be working, computed by processing work time information and break time information and excluding at least the break time information.

The term “overtime total” refers to an aggregated amount of time, for a given calendar unit or another defined period, during which actual work time exceeds a reference working duration.

The term “calendar unit” refers to a time period defined by a calendar, such as a day, a week, or a month, over which work time and overtime totals are aggregated.

The term “time threshold” refers to a reference duration value stored as setting information, used as a comparison standard for determining whether an overtime total has exceeded a particular limit.

The term “setting information” refers to configuration data stored in a memory or storage device, including at least threshold values, classification rules, and parameters used for controlling processing by the system.

The term “warning” refers to notification data generated by the system in response to an event such as an overtime total exceeding a time threshold, and provided to at least one of a user or a manager.

The term “electronic communication function” refers to a capability of the system to transmit notification data via an electronic messaging mechanism, such as an email message or a push notification.

The term “display function” refers to a capability of the system to present information visually on a display device of a user terminal or an administrator terminal.

The term “free-description information” refers to text or other unstructured content input by a user without being constrained to a predefined set of options, typically entered into a remark field.

The term “character-string analysis processing” refers to an operation in which free-description information is programmatically analyzed by processing character sequences, for example by pattern matching, tokenization, or language modeling.

The term “intermediate absence behavior” refers to a user's temporary absence from a working place or working state during a working period, other than predefined break periods, as inferred from remark content.

The term “eating and drinking behavior” refers to a user's consumption of food or beverages during a break or intermediate absence, as inferred from remark content.

The term “classification information” refers to structured data indicating a category or type assigned to a behavior or record, including at least categories for intermediate absence behavior and eating and drinking behavior.

The term “work status record” refers to a stored data record that represents a user's attendance-related state, including at least work time information, break time information, actual work time, and any associated classification information.

The term “access control” refers to a security mechanism implemented in hardware or software that restricts access to stored data based on authentication, authorization, or permission settings.

The term “data storage device” refers to one or more hardware storage units, such as a database system or a file storage subsystem, configured to store work status records, aggregation results, and warning histories.

The term “warning history” refers to stored data representing past warning events, including at least a time of issuance, a type of warning, and associated user or record identifiers.

The term “manager display screen” refers to a user interface view provided to a managing user, which includes aggregated information about attendance, overtime totals, classifications, and warning history.

The term “administrator-oriented summary data” refers to aggregated and formatted data intended for managerial review, including statistics, lists, or indicators derived from work status records, overtime totals, and warning history.

The term “expression set” refers to a predefined collection of words, phrases, or patterns used by the system to detect specific types of behaviors in free-description information.

The term “trained language model” refers to a machine-learned model that has been trained on language data to generate, interpret, or classify text, and that is used to analyze remarks and detect behaviors such as intermediate absences and eating and drinking.

The term “machine-readable and query-efficient format” refers to a data format, such as a structured record or table, that can be programmatically accessed, filtered, and aggregated with reduced computational overhead.

The term “internal processing unit” refers to a logical or software-defined component within the server or organization that is responsible for handling a subset of user information classified by the system.

The server operates as a network-accessible attendance management and information routing platform implemented on general-purpose computing hardware. The server includes at least one processor, such as a multi-core central processing unit, at least one memory device, such as dynamic random-access memory, and at least one non-volatile storage device, such as a magnetic disk drive or a solid-state drive. The server executes an operating system, such as a general-purpose server operating system, and runs application software implemented, for example, in a high-level programming language such as Python or Java. In one embodiment, the server uses a web application framework, such as a Python-based framework or a Java-based framework, and exposes application programming interfaces and web pages via a web server, such as a generic HTTP server. The server interacts with a relational database management system, such as a structured query language database engine, which stores attendance records, configuration parameters, classification results, and warning histories in structured tables.

The terminal is a computing device with a display, an input unit, a network interface, and a browser or dedicated client application. The terminal can be a desktop computer, a notebook computer, a handheld device, or another network-capable device. The terminal executes a browser to render hypertext documents and to run client-side scripts. The terminal establishes an encrypted communication channel with the server via a communication network, such as a packet-switched network, using a secure transport protocol.

The user operates the terminal to access an attendance management screen provided by the server. The server transmits markup documents and script resources that define graphical elements, including input fields for work start time, work end time, break intervals, and free-text remarks. The terminal renders these graphical elements, and the user enters data using a pointing device, keyboard, or touch panel. The terminal may perform basic format validation using client-side script code before transmitting the data to the server.

The server receives user information from the terminal in structured payloads, such as form-encoded messages or structured text. The user information includes fields for dates, timestamps, identification data, and free-text remark content. The server stores the raw payload in a message buffer in memory, parses the payload, and maps fields into internal data structures, such as attendance record objects or database rows. The server then passes selected text fields to a generative artificial intelligence model deployed as part of the application.

The server provides the generative artificial intelligence model as a trained neural network executed on a hardware accelerator or on the central processing unit. In one embodiment, the model is implemented as a transformer-based neural network that includes multiple encoder and decoder layers. The model receives tokenized text as input, where the server converts each character sequence into a sequence of token identifiers using a vocabulary and tokenization rules stored in memory. The model uses learned embedding vectors to map tokens into continuous feature spaces and processes the sequence with multi-head self-attention layers, feedforward layers, and normalization layers. The model outputs contextualized token representations and derived classification vectors for semantic intent and emotional state.

The server configures the generative artificial intelligence model with multiple output heads, including at least a routing head and an emotion head. The routing head outputs a probability distribution over a predefined set of internal processing categories, such as attendance processing, complaint handling, and general inquiry, based on a softmax transformation of a linear projection of the final hidden representations. The emotion head outputs scores for emotional states, such as urgency, stress, or neutrality, using a similar projection and normalization. The server uses threshold values stored in configuration tables to convert probability distributions into discrete labels. For example, the server may consider the category with the maximum probability as the routing target and may classify the emotional state as urgent when a corresponding score exceeds a threshold.

The server obtains classification results and emotional scores from the model and writes them into associated fields in the attendance record data structure. The server then uses the routing information to determine which internal processing unit should receive the record for further processing. The server updates routing tables or message queues corresponding to different processing units. This approach, in which routing is derived from high-dimensional contextual embeddings and learned attention patterns rather than from simple keyword rules, enables more accurate and flexible alignment between user input and server-side processing modules. As a result, the server reduces misrouting and redundant processing cycles, thereby improving overall throughput and reducing network and storage load.

The server calculates a processing priority for each record based on the emotional scores and additional context, such as historical overtime data or previous warnings. For example, the server may compute a priority score as a weighted sum of an urgency score, an overtime ratio, and a recency factor. The server stores this priority score in a numeric field and uses it to order entries in processing queues. By adjusting the scheduling of server tasks and allocating more processing resources to higher-priority entries, the server reduces latency for critical operations while maintaining acceptable responsiveness for routine operations, thereby improving the behavior and efficiency of the system as a whole.

The server manages attendance data using dedicated tables in the database. One table may store user master data, including user identifiers. Another table may store daily attendance records, with columns such as record identifier, user identifier, date, start time, end time, break start time, break end time, actual work duration, overtime duration, and remark text. The server represents time values in a normalized time format and uses arithmetic operations on these numeric representations to calculate durations. The server computes actual work time by subtracting total break duration from the difference between end time and start time, and writes the result as a numeric value, such as minutes or seconds, into the corresponding column. The server then updates an overtime total table or performs aggregation queries to compute overtime per calendar unit, such as a month. The server may use database aggregation functions or precomputed caches to reduce computational complexity and to respond quickly to user queries.

The server compares the aggregated overtime totals with at least one time threshold that is stored in a configuration table. The configuration table may include fields such as threshold identifier, duration value, and applicable user group. The server retrieves the applicable threshold for a given user, converts both the overtime total and the threshold into a comparable numeric representation, and performs a comparison. When the overtime total exceeds the threshold, the server generates a warning event object, with fields such as user identifier, timestamp, overtime value, threshold value, and event type. The server stores this event object into a warning history table, thereby creating a machine-readable sequence of warning events that can be indexed and queried using time-based and user-based indices.

The server sends warning notifications via at least one communication channel. For email-based warnings, the server uses a messaging library to construct an electronic message, including subject, body, and recipient addresses. The server connects to a mail transfer service using a standardized protocol, performs authentication when required, and transmits the message. For on-screen warnings, the server writes a flag field in the attendance record or in a user notification table, and returns this flag in response payloads when the terminal requests status updates. This approach ensures that warning information is consistently integrated into both asynchronous communication and interactive user interfaces.

The server analyzes free-text remarks to detect intermediate absence behaviors and eating and drinking behaviors. The server first executes a lightweight pattern-matching module that scans the remark string for entries in an expression set stored in configuration. This expression set contains canonical phrases and synonyms associated with certain behaviors. The server tokenizes the string and performs matching using efficient string search algorithms. If the pattern-matching module yields ambiguous or low-confidence results, the server may invoke a classifier built on a trained language model, such as a smaller neural network fine-tuned on labeled remark data. This classifier uses embedding vectors and fully connected layers to output behavior labels, such as “out-of-office break,” “in-office break,” or “meal included.” The server converts these labels into classification codes and stores them in dedicated columns in the attendance record table.

The server uses these classification codes to refine its computation of actual work time and to generate richer analytics. For example, the server may treat certain out-of-office breaks differently from in-office breaks in accordance with predefined rules. By encoding semantic behaviors into discrete codes rather than storing only unstructured text, the server can execute more precise and efficient queries. This reduces the need for repeated full-text scanning and improves the performance of statistical analysis modules. Furthermore, the server can compress codes more efficiently and index them more effectively than arbitrary text, which reduces storage space and improves retrieval speed.

The server periodically aggregates attendance data, classification codes, overtime totals, and warning histories into administrator-oriented summary data. The server may run scheduled tasks under a job scheduler to perform nightly or hourly aggregations. During aggregation, the server reads raw records, computes statistics such as total work time, average break length, number of eating and drinking events, and number of warnings issued, and stores the results in summary tables. The server also computes derived indicators, such as overtime ratio and warning density, and writes these into numeric fields. By reusing these precomputed summary tables when responding to dashboard queries, the server significantly reduces the number of expensive full-table scans and complex joins, leading to faster response times for administrators and lower CPU and I/O load on the server.

The server generates an administrator display screen that presents the summary data. The server composes markup documents that include table elements and scripting code to render charts and graphs using client-side libraries. The server embeds summary data into structured data objects within the markup or provides separate endpoints that deliver data in structured text form. The terminal loads the markup and script code, parses the embedded data, and draws visualizations such as bar charts, line graphs, and heat maps. The administrator can use the terminal to filter results, adjust thresholds, and inspect individual records. When the administrator changes configuration parameters, such as the overtime threshold or expression set entries, the terminal sends configuration update messages to the server. The server validates the new values, updates configuration tables, and logs changes to a configuration history log for auditability.

The user can also interact with a generative AI model through prompt sentences for debugging, documentation, or explanation purposes. For example, the user may input the following prompt sentence into a separate generative model interface: “Describe, with explicit step-by-step processing, how a server, a terminal, and a user interact in a web-based attendance management system: from user input of working hours and remarks on the terminal, through HTTPS transmission, server-side validation and database storage, overtime aggregation and threshold comparison, to email alert generation and dashboard visualization.”

In another example, the user may input:

“Explain in concrete program-level steps how a server implemented with a high-level language and a relational database receives attendance data from terminals, calculates actual working time by subtracting break intervals, classifies free-text remarks about out-of-office meals, records alert history when monthly overtime exceeds a threshold, and presents the results on an administrator dashboard.”

These prompt sentences illustrate how the generative AI model can be used to generate human-readable descriptions and diagnostics for the system, which can be stored by the server as documentation or used as training material for operators.

The server improves computer technology itself rather than merely automating a business procedure. By integrating a transformer-based generative artificial intelligence model into the core data processing pipeline, the server converts unstructured textual inputs into structured objects with semantic labels and emotional scores. This conversion allows the server to optimize database layouts, query plans, and scheduling algorithms in ways that rule-based systems cannot achieve. For example, by using learned embeddings and multi-head attention, the model can derive fine-grained distinctions between similar phrases, thereby reducing misclassification and reducing the number of corrective transactions that would otherwise require additional database writes and reads. This directly lowers storage wear and network utilization, and reduces the probability of inconsistent records.

The server employs non-conventional procedures for managing priorities and routing. Instead of processing inputs in a simple first-in-first-out order, the server uses numeric priority values derived from emotional analysis and historical overtime metrics. This priority is computed according to algorithmic rules that are applied uniformly and automatically by the processor. As a result, tasks that are more urgent or more critical for system integrity are processed sooner, which leads to measurable reductions in worst-case response times and prevents accumulation of high-risk cases in the queue. This scheduling mechanism improves system stability and throughput beyond what can be achieved by human operators or naive scheduling.

The server uses specific learning methods to train the generative artificial intelligence model before deployment. During training, the server or a training environment constructs batches of tokenized text and associated labels for routing categories and emotions. The server defines a loss function that combines a categorical cross-entropy term for routing labels and another categorical or ordinal loss term for emotional states. The server executes forward passes through the neural network to obtain predicted distributions and calculates the loss. The server then applies backpropagation to compute gradients with respect to model weights and uses an optimization algorithm, such as a variant of stochastic gradient descent with adaptive learning rates, to update the weights. Data augmentation techniques, such as synonym replacement and random masking, may be applied to training sentences to improve robustness and generalization. By carefully designing and training the model in this way, the server obtains a neural network that produces reliable and compact representations suitable for downstream use, which enhances the predictive accuracy and stability of the deployed system.

The server balances computational load by selectively invoking heavy neural inference only when necessary. For example, the server may apply a lightweight keyword-based filter to identify user inputs that clearly match predefined patterns, and may bypass the generative model for such cases. Only ambiguous or complex inputs are processed by the full model. This conditional invocation reduces average computational cost and energy consumption, while maintaining high accuracy where it is most needed. The server can dynamically adjust thresholds for invoking the model based on current CPU load, latency targets, or other system performance indicators.

The server and terminal cooperate to ensure secure and efficient data transfer. The terminal establishes secure channels with the server, and the server terminates secure sessions using cryptographic operations performed by the processor. By encrypting and authenticating messages, the server ensures confidentiality and integrity of attendance data and warning notifications. The server also compresses certain payloads or strips unnecessary fields when transferring summary data to reduce bandwidth consumption. The combination of secure transport and optimized payloads leads to reduced communication overhead, faster page loads, and improved user experience.

In an alternative embodiment, the server may execute the generative artificial intelligence model on a separate inference service. The server sends encoded text and receives classification outputs from the inference service over an internal network. The server still integrates the outputs into the same data structures and control flows described above. This modular architecture allows the system to scale by deploying multiple inference instances or by using specialized hardware. Despite the distribution of computation, the logical operations and technical effects remain the same: more accurate classification, better routing, and improved use of storage and processing resources.

In another embodiment, the server may adjust its internal database schema based on the types of classifications that occur most frequently. For example, the server might automatically create new indices on columns corresponding to high-frequency classification codes or warning types. The server can monitor query performance metrics, such as average query time for particular reports, and modify indexing strategies accordingly. This dynamic adaptation is guided by aggregated classification statistics produced by the generative model, demonstrating a feedback loop in which model outputs directly influence hardware resource usage and data organization.

The user, the terminal, and the server thus interact in a system in which the generative artificial intelligence model is not merely an add-on for human convenience but is an integral component of data routing, storage optimization, priority calculation, and warning management. The resulting system improves the way a computer processes, stores, and presents data, providing measurable benefits such as increased accuracy of attendance records, reduced misclassification of behaviors, shortened response times for critical events, and lower computational and communication overhead across the system.

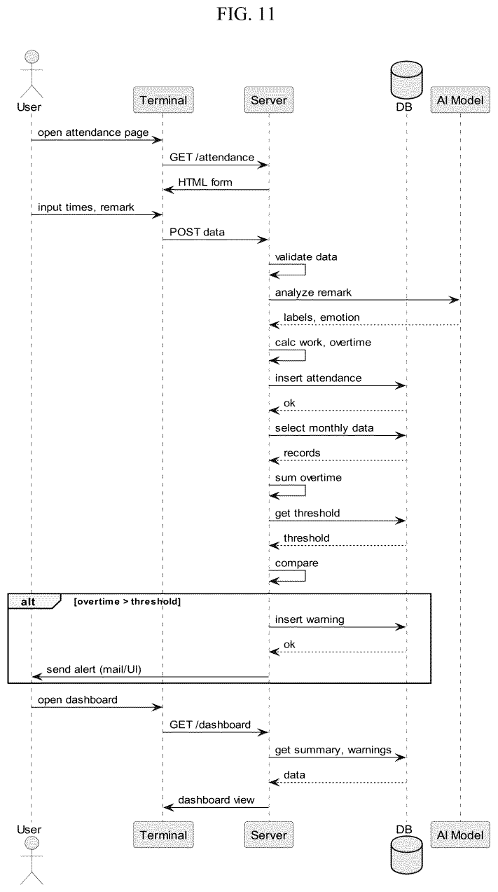

The following describes the processing flow using FIG. 11.
Step 1:

The user operates the terminal to access an attendance management screen provided by the server.

The terminal sends a request to the server for an attendance input page as input data.

The server returns an HTML and script document defining input fields for work start time, work end time, break period, and remark text as output data.

The terminal renders the received document, executes embedded scripts, and displays the attendance form on the display device.
Step 2:

The user enters work start time, work end time, break start time, break end time, and a free-text remark into the form fields on the terminal.

The terminal receives these values as input data from the user through a keyboard or touch interface.

The terminal performs basic client-side validation, such as checking the time format and non-empty required fields, and generates a structured payload (for example, key-value pairs) as output data.

The terminal sends the structured payload to the server over a secure communication channel.
Step 3:

The server receives the structured payload containing attendance fields and remark text from the terminal as input data.

The server parses the payload using server-side application logic, converting text fields into internal data structures, such as objects or records, as output data.

The server validates logical consistency (for example, start time earlier than end time, break within work period) by performing comparisons on time values; if validation fails, the server generates an error response as output data.

The terminal receives the error response and displays validation messages to the user, prompting correction.
Step 4:

The server converts valid time strings (start, end, break start, break end) into normalized time representations as input data for duration computation.

The server calculates total work interval by subtracting the normalized start time from the normalized end time, and calculates break duration by subtracting break start from break end, producing numeric duration values as output data.

The server computes actual work time by subtracting break duration from total work interval, generating an actual work duration value as output data.

The server stores the normalized times and computed durations in a temporary attendance record structure for later database insertion.
Step 5:

The server prepares the free-text remark and other user information (such as user identifier and date) as input data for the generative AI model.

The server tokenizes the remark text into tokens, maps tokens to numeric IDs, and creates an input tensor as model input data.

The server executes a generative AI model, such as a transformer-based neural network, which processes the input tensor and outputs semantic embeddings, routing probabilities, and emotion scores as output data.

The server receives the model outputs and stores the routing label and emotional state label in fields attached to the attendance record.
Step 6:

The server uses the model's semantic embeddings and a classification head to infer behavior labels for intermediate absence and eating/drinking from the remark as input data.

The server applies thresholding and maximum-probability selection on the behavior label probabilities, yielding discrete behavior codes, such as “out-of-office break” or “meal included,” as output data.

The server writes these behavior codes into classification fields of the attendance record, alongside the original remark text.

The server thereby transforms unstructured text into structured, machine-usable classification data.
Step 7:

The server opens a connection to the database management system and receives the attendance record (with normalized times, durations, labels, and codes) as input data for storage.

The server constructs an insertion command that maps the record fields to columns in an attendance table and executes the command, writing a new row as output data in persistent storage.

The server commits the transaction so that the attendance row and associated classification information become durable.

The server may obtain the newly assigned record identifier from the database as output data and store it in memory for subsequent processing.
Step 8:

The server collects all attendance records for the relevant user and calendar period, such as a month, from the database as input data.

The server performs aggregation by summing daily overtime durations or by subtracting a base working duration from total actual work durations, computing an overtime total as output data.

The server may use database aggregation functions to reduce memory load, receiving the aggregated value directly from the database as output data.

The server stores the overtime total in a monthly summary structure associated with the user.
Step 9:

The server retrieves a configured time threshold applicable to the user from a configuration table as input data.

The server compares the computed overtime total with the time threshold using numeric comparison operations, producing a comparison result (exceeded/not-exceeded) as output data.

The server, when the comparison result indicates that the overtime total exceeds the threshold, creates a warning event object containing user identifier, overtime value, threshold value, and a timestamp as output data.

The server writes the warning event object into a warning history table, thereby updating the warning log in persistent storage.
Step 10:

The server uses the warning event object as input data to construct notification content for email or in-system alerts.

The server fills a message template with dynamic values (user name, period, overtime total, threshold) and generates a complete notification message string as output data.

The server connects to a messaging service, transmits the notification message to the appropriate address or channel, and records the delivery status as output data in a log or status table.

The terminal, when later requesting status, receives notification flags or messages from the server and displays them on the user interface.
Step 11:

The server periodically retrieves attendance records, behavior classifications, overtime totals, and warning histories from the database as input data for summarization.

The server computes aggregated indicators, such as total work time per period, count of out-of-office breaks, number of eating/drinking events, and count of warnings, producing summary metrics as output data.

The server stores these metrics in summary tables or caches to serve future dashboard queries efficiently.

The server generates a data package containing the summary metrics and associated labels as output data for display.
Step 12:

The server receives a dashboard request from an administrator terminal as input data.

The server fetches relevant summary metrics and warning histories from the summary tables and constructs a response page containing tabular data and embedded structured data for chart rendering as output data.

The terminal receives the dashboard response and executes client-side scripts to parse the embedded data and draw graphs on the display.

The administrator views the graphs and tables and optionally modifies configuration settings, such as time thresholds or classification expression sets.
Step 13:

The user, acting as an administrator or operator, inputs new configuration values (for example, a different overtime threshold or updated behavior expressions) into configuration forms on the terminal.

The terminal sends the new configuration values to the server as input data in a configuration update request.

The server validates the configuration values, converts them into appropriate data types, and writes them into configuration tables in the database as output data.

The server logs the change by storing a configuration change record with old values, new values, and timestamps, which is used for future audits.
Step 14:

The server, in some embodiments, receives prompt sentences from a separate generative AI interface as input data for system documentation or explanation.

The server may store the prompt sentences and the generated explanations in a documentation table as output data, associating them with specific modules or configuration versions.

The server can later retrieve these stored explanations as input data for display on help pages or for training new administrators.

The terminal displays these explanations to the user when requested, thereby improving understanding of the system's internal processes.
Step 15:

The server monitors processing time, queue length, and CPU load as input data for adaptive model invocation.

The server calculates thresholds for when to apply full generative AI analysis versus lightweight rule-based analysis, outputting a decision flag as output data for each new request.

The server, when the decision flag indicates heavy-load conditions, routes simple or clearly patterned remarks to a rule-based classifier and reserves the generative AI model for ambiguous cases, reducing overall computation time.

The server thereby optimizes resource usage and maintains response times by adjusting which processing path is taken based on current system state.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional attendance management systems typically rely on simple time-stamp logging and rule-based aggregation. These systems record clock-in and clock-out times, compute working hours and overtime, and sometimes store free-text remarks. However, such systems exhibit several technical limitations.

First, conventional systems generally treat attendance data, overtime data, and remark data as independent records and do not generate machine-readable, semantically structured prompts that can be directly consumed by a generative artificial intelligence model. As a result, any higher-level analysis or explanation of complex attendance patterns must be manually prepared by a human operator, which increases processing latency, limits scalability, and prevents real-time, automated feedback.

Second, conventional systems do not integrate emotional-state analysis and detailed mid-shift context, such as reasons for mid-shift absences and presence or absence of meals, into the core computation pipeline for overtime and health-related indicators. Even when such information is stored, it is typically handled as unstructured text that is not systematically used to compute indices relating to actual working conditions and health conditions, nor to drive automated warnings or recommendations. This leads to an underutilization of available data and reduces the ability of the system to provide precise, context-aware control of warnings and workload balancing.

Third, existing systems often lack a unified processor-controlled mechanism that (i) reads user identification information from an identification medium, (ii) records work start, break, and work end events in real time, (iii) calculates actual working duration by subtracting break durations, (iv) automatically generates a structured prompt sentence based on aggregated attendance and overtime data, and (v) transmits the prompt sentence together with the aggregated data to a generative artificial intelligence model via a communication interface. Without such an integrated mechanism, system behavior remains fragmented, and the computational pipeline from raw sensor inputs to high-level AI-driven analysis is not optimized.

Fourth, in many deployments, warnings regarding excessive overtime are generated using static threshold checks implemented as simple conditional branches, without using aggregated context such as patterns in mid-shift absences, missing meals, or user emotional state. This results in a high rate of either missed risks or false positives, and does not provide administrators or users with machine-generated explanations or improvement proposals that are tailored to the specific attendance patterns present in the data.

Accordingly, there is a need for an improved computer-implemented system in which a processor coordinates real-time acquisition of user-identification and time information, computes actual working durations and overtime durations, enriches these values with structured remark information and health-related indices, automatically generates prompt sentences and aggregated data suitable for input to a generative artificial intelligence model, and uses the resulting analysis output to produce explanation information and improvement-proposal information. Such a system would improve the technical functioning of attendance management platforms by enabling automated, low-latency, and context-aware feedback and by reducing the amount of human intervention required to interpret and act on complex attendance and overtime data.

The specific processing by the specific processing unit 290 of the data processing device 12 in Application Example 1 is realized by the following means.

The present invention provides a server comprising a processor configured to receive information including user identification information, to read the user identification information from an identification medium via a reading device, to record in real time a work start time, a break start time, a break end time, and a work end time of the user in a time-information storage device by using the user identification information and time information obtained from a time source, to accept, based on a declaration by the user, input of clock-in, clock-out, and break times and record the input as attendance information, to calculate an actual working duration by subtracting a total break duration from a working duration between the work start time and the work end time, to calculate an overtime duration exceeding a reference working duration and aggregate a total overtime duration for each user, to acquire, through a remark input from the user, information relating to a reason for a mid-shift absence and presence or absence of a meal and record the information in association with the attendance information, to aggregate the attendance information, the overtime duration information, and the remark information and generate aggregated data for display to a supervisor, to automatically generate a prompt sentence for input to a generative artificial intelligence model based on the aggregated data including the attendance information and the overtime duration information, to transmit the prompt sentence together with the aggregated data to the generative artificial intelligence model via a communication interface, and to generate, based on an analysis result received from the generative artificial intelligence model, explanation information or improvement-proposal information for the user or the supervisor and output the explanation information or the improvement-proposal information to a display device. This enables an integrated computer-implemented pipeline in which attendance data and context data are automatically collected, normalized, and transformed into machine-interpretable prompts for a generative artificial intelligence model, and in which the resulting analysis is fed back into the system as structured warnings, explanations, and recommendations, thereby improving the technical operation of attendance management by reducing processing latency, enhancing accuracy and granularity of overtime and health-related indices, and decreasing dependence on manual interpretation of complex time-series and remark data.

The term “processor” refers to a hardware information-processing unit, such as a central processing unit or other arithmetic and logic circuitry, that executes instructions to perform the functions described in the claims.

The term “user” refers to a human operator whose identification information, attendance information, emotional state, and remark information are processed by the system.

The term “identification information” refers to data that uniquely or quasi-uniquely distinguishes a user from other users, such as a numeric identifier, an alphanumeric identifier, or encoded card data read from an identification medium.

The term “identification medium” refers to a physical or electronic carrier that stores identification information of a user, such as a card, tag, token, or other machine-readable medium capable of being read by a reading device.

The term “reading device” refers to hardware configured to obtain identification information from an identification medium, such as a card reader, tag reader, or other sensor-based reader.

The term “time-information storage device” refers to a storage resource, such as a memory or database, in which time-related data including work start, break, and work end times are recorded and maintained.

The term “time source” refers to a hardware or software component that provides current time information, such as a system clock, a network time service, or another timing mechanism.

The term “attendance information” refers to structured data representing a user's work-related time records, including clock-in times, clock-out times, break times, and associated metadata.

The term “working duration” refers to a time interval between a work start time and a work end time for a given work period, before subtraction of break durations.

The term “break duration” refers to a time interval or accumulated time representing a period during which the user is in a non-working break state within a work period.

The term “actual working duration” refers to an effective working time obtained by subtracting a total break duration from a working duration between a work start time and a work end time.

The term “reference working duration” refers to a predetermined time value representing a standard or baseline working time used to determine whether an overtime duration occurs.

The term “overtime duration” refers to a time value representing an amount of work time that exceeds a reference working duration during a predetermined period.

The term “total overtime duration” refers to an aggregated overtime duration computed for each user over a specified aggregation period, such as a day, week, or month.

The term “remark input” refers to user-entered information, including text or selection data, that provides contextual details such as reasons for mid-shift absences and presence or absence of meals.

The term “remark information” refers to data obtained from a remark input, stored in association with attendance information, and describing contextual aspects of a user's working behavior.

The term “mid-shift absence” refers to a period within a work shift during which the user temporarily leaves a normal working activity or workplace, excluding regular breaks, and for which a reason can be recorded.

The term “presence or absence of a meal” refers to an indication, provided by the user or derived by the system, specifying whether the user has taken a meal during a work period.

The term “aggregated data” refers to processed and combined data generated from attendance information, overtime duration information, remark information, and other related records, formatted for analysis or display.

The term “supervisor” refers to a person responsible for managing or monitoring users'working conditions, who views aggregated data, explanations, or recommendations output by the system.

The term “warning information” refers to data representing an alert condition, including content that indicates that a total overtime duration has exceeded a threshold or that another notable condition has occurred.

The term “audio warning” refers to warning information presented to a user through sound output, such as a spoken message or tone generated by an audio output device.

The term “display warning” refers to warning information presented to a user visually through a display device, such as a message, icon, or graphical indicator.

The term “audio output device” refers to hardware capable of converting electronic warning information into sound, such as a speaker, buzzer, or headphone interface.

The term “display device” refers to hardware capable of visually presenting information, such as a monitor, terminal screen, or other visual display panel.

The term “generative artificial intelligence model” refers to a software-implemented model that generates text or other content based on input data and a prompt sentence, such as a machine learning or neural network model capable of natural-language generation.

The term “generative artificial intelligence means” refers to functional components, including a generative artificial intelligence model and associated software and hardware resources, configured to analyze input data and produce generated output content.

The term “prompt sentence” refers to a structured textual instruction or query that is supplied, together with associated data, as input to a generative artificial intelligence model in order to control the content and focus of the model's output.

The term “communication interface” refers to hardware and software components that enable data exchange between the server and external devices or services, including communication with a generative artificial intelligence model.

The term “analysis result” refers to output data produced by a generative artificial intelligence model or another analytical process, including explanations, classifications, summaries, or recommendations derived from input data.

The term “explanation information” refers to output content that interprets or clarifies attendance information, overtime duration information, or related indices for a user or supervisor in a human-understandable form.

The term “improvement-proposal information” refers to output content that proposes changes or recommendations regarding working hours, breaks, scheduling, or other operational aspects based on analysis of attendance information and related data.

In one embodiment, a server implements the claimed system by executing a computer program on one or more processors and controlling associated memory, storage, and communication interfaces. The server uses an operating system, an application framework such as a web application framework, a relational database management engine, and a generative AI inference runtime. The server cooperates with one or more terminals that incorporate displays, audio output devices, input interfaces, and identification media readers, and with users who provide identification inputs, attendance declarations, and remark inputs. The server stores, in a non-transitory storage device, a set of program modules including at least: an identification management module, an attendance recording module, a time computation module, a remark management module, an aggregation module, an AI-prompt generation module, an AI-communication module, and an AI-result integration module. The server also stores a relational database, for example implemented using a relational database engine such as SQLite or another relational database system, that includes tables for workers, raw time events, attendance summaries, overtime summaries, and remark records.

The terminal includes an input device such as a touch-sensitive display or keypad, an audio output device such as a speaker, a display device such as a liquid crystal display, and an identification reading device such as a contact or contactless card reader. The terminal executes a user-interface program that may be provided as a browser-based interface delivered from the server, implemented for example using HTML, CSS, and JavaScript, or as a native application. The terminal communicates with the server via a data network using a communication protocol such as HTTP or HTTPS.

The user holds or possesses an identification medium such as a card or tag that stores identification information in a machine-readable form. The user presents the identification medium to the terminal's reading device and operates the terminal user interface to declare attendance events and enter remark information. The user also views explanations and improvement proposals that are presented on the terminal display or that are played as audio output.

The server uses the identification management module to receive identification information from the terminal. When the terminal reads identification information from the identification medium, the terminal sends that identification information to the server as structured data via the communication interface. The server validates the identification information against the worker table in the relational database and generates an internal worker identifier. The server then passes this internal worker identifier to the attendance recording module.

The server uses the attendance recording module to store time information in a time-information storage device. The server obtains a current time from a time source such as a system clock synchronized with a network time protocol server, and records the time as a work start time, a break start time, a break end time, or a work end time in the raw time events table. Each record includes at least the internal worker identifier, a timestamp, an event type, and optional metadata such as the terminal identifier and location. By centralizing the time stamping on the server-side clock, the system avoids inconsistencies caused by unsynchronized terminal clocks and improves the accuracy and repeatability of the recorded times.

The server uses the time computation module to compute an actual working duration and an overtime duration. The server groups raw time events into work sessions by worker and date or shift identifier stored in the database. For each session, the server calculates a working duration as a difference between the recorded work start time and the recorded work end time. The server then sums the durations of all associated break intervals, each represented by a corresponding break start time and break end time, and subtracts the total break duration from the working duration to obtain an actual working duration. The server computes an overtime duration by comparing the actual working duration to a reference working duration stored as configuration data in the database. If the actual working duration exceeds the reference working duration, the server records the difference as the overtime duration for that session. The server aggregates overtime durations across sessions to obtain a total overtime duration for a given aggregation period, such as a week or a month, and stores the aggregation result in an overtime summary table.

The server uses the remark management module to process remark inputs. The user enters a remark, for example “Left factory for delivery from 13:00 to 14:00” or “No meal taken,” via the terminal interface. The terminal sends the remark text, together with the internal worker identifier and the related date or shift identifier, to the server. The server stores the remark in a remark table, linked via a foreign key to the corresponding attendance record. The remark management module also categorizes remarks into structured fields, for example by detecting whether the remark corresponds to a mid-shift absence or whether a meal was taken, using pattern matching or a lightweight classifier. This categorization allows the server to compute indices relating to actual working conditions and health conditions, such as “number of shifts without a recorded meal” or “frequency of mid-shift exits,” which are stored as numeric or categorical fields associated with each worker and shift.

The server uses the aggregation module to generate aggregated data for supervisors and for subsequent AI processing. The aggregation module retrieves attendance information, overtime duration information, and remark information from the database using structured queries. The module joins tables on worker identifiers and time keys, and constructs aggregate data structures that include, for each worker and period: total actual working duration, total overtime duration, counts and durations of mid-shift absences, presence or absence of meals, and derived health-related indices. The aggregated data is stored in memory or in materialized views to reduce repeated computation. By precomputing and caching aggregated data, the server reduces processing latency when later generating warnings and AI prompts.

In one embodiment, the server uses a web application framework such as a Python-based web framework to implement an application server that exposes application programming interfaces for terminals and management consoles. The server provides endpoints for time-event registration, remark submission, status retrieval, and AI-analysis retrieval. The server program uses a module structure in which each of the above-mentioned functional modules is implemented as a separate logical component that cooperates via defined interfaces and shared database access.

The server uses the AI-prompt generation module and the AI-communication module to interface with a generative AI model. The AI-prompt generation module converts aggregated data into a textual representation suitable for analysis by a generative AI model. For example, the module can generate structured text including entries such as:

“Worker A: total hours this week: 52; overtime: 12; number of days without meal remarks: 3; mid-shift absences: 2 (technical visit, delivery).

Worker B: total hours this week: 44; overtime: 4; number of days without meal remarks: 0; mid-shift absences: 0.”

The AI-prompt generation module then constructs a prompt sentence that frames a specific analytical task for the generative AI model. In one embodiment, the module generates a prompt sentence such as:

“Given the following weekly attendance and overtime summary for each worker, identify who is at risk of exceeding 44 hours of overtime and explain any patterns in late breaks or missing meal remarks.”

In another embodiment, the module generates a prompt sentence such as:

“Explain how the terminal records working hours, manages breaks, and controls overtime for factory workers in this attendance system.”

The server concatenates the prompt sentence and the aggregated data into a single text sequence and passes this sequence to the AI-communication module. The AI-communication module then transmits the text sequence to a generative AI model via an external or internal inference interface.

In one embodiment, the generative AI model is a transformer-based neural network that has an encoder-decoder or decoder-only architecture. The model includes an embedding layer that converts input tokens into embedding vectors, multiple self-attention layers that capture long-range dependencies across tokens, and feed-forward layers that compute nonlinear transformations of intermediate representations. The model has been trained on a mixture of general language data and domain-specific synthetic attendance data to learn relationships between overtime patterns, remark patterns, and risk indicators.

The server stores or accesses model parameters for the generative AI model, including weight matrices and bias vectors for each layer. The model processes input text tokens using multi-head self-attention, in which the model computes attention weights that represent the relevance of each token with respect to others based on learned query, key, and value projections. The model then aggregates weighted values to produce context-sensitive representations. The model finally generates output tokens one by one using a probabilistic decoding algorithm such as greedy decoding or beam search, controlled by a temperature parameter that influences the diversity of the output. The server configures these parameters via the AI-communication module to reduce randomness and improve consistency in the generated analyses.

During training, the generative AI model uses a loss function such as cross-entropy between predicted token distributions and target token distributions, and a weight update algorithm such as stochastic gradient descent or an adaptive variant. The model applies regularization techniques and data augmentation techniques, such as paraphrasing of attendance summaries and variation in threshold conditions, to increase robustness. As a result, the model develops nontrivial mappings from structured attendance patterns to narrative explanations and recommendations that would be difficult to replicate through static rule-based logic.

The server uses the AI-result integration module to interpret the analysis result returned by the generative AI model. The analysis result may include, for example, natural-language paragraphs that identify specific workers whose total overtime duration is near or above a configured threshold, explanations linking mid-shift absences and missing meals to potential health risks, and suggested scheduling adjustments. The AI-result integration module parses the result into segments, maps references to workers back to internal worker identifiers using heuristic or rule-based matching, and stores key recommendations in a dedicated table. The server then generates explanation information and improvement-proposal information as structured content that can be rendered on the terminal or on a management console.

The terminal displays the explanation information and improvement-proposal information on its display device. For example, the terminal may show a message such as “Your overtime has exceeded 44 hours this month; consider taking additional breaks” or “Based on your recent patterns of missing meal records, please ensure to record meal breaks.” The terminal also uses the audio output device to synthesize or play back corresponding audio messages, thus enabling users to receive warnings and explanations even when they are not directly looking at the display.

The server integrates the AI-derived explanations with deterministic computations of overtime and break durations. The server uses a combination of rule-based checks and model-based analyses. For example, the server can generate an immediate rule-based warning when a total overtime duration exceeds a numerical threshold, and can subsequently request a deeper generative AI analysis to explain why the overtime occurred and how to re-balance shifts across multiple users. This hybrid use of deterministic and neural-network-based processing improves both the accuracy and interpretability of the system outputs.

The system achieves technical improvements in several respects. By offloading the time stamping to a centralized server with a synchronized time source and by maintaining time events in normalized relational tables, the system reduces inconsistency errors and improves the precision of computed actual working durations and overtime durations. By precomputing aggregated data structures and by caching indices for each worker, the system reduces computation time when responding to queries from terminals and management consoles, thereby improving throughput and reducing latency under high load.

By generating structured prompt sentences and formatted aggregated data that are specifically tailored to the generative AI model's token structure and training distribution, the server reduces the number of tokens required to express a given analytical query. This reduction decreases communication overhead between the server and the AI inference engine and also shortens inference time because the model processes fewer tokens. Consequently, the system can provide near real-time feedback to users and supervisors, which is not a trivial automation of manual interpretation but rather a reconfiguration of the computational pipeline to exploit the strengths of the model architecture while managing resource consumption.

The system also improves data management and error robustness. Because the server stores raw time events, aggregated attendance summaries, and AI-generated explanations in separate but linked tables, the server can reconstruct and verify the entire processing chain. This structure enables automatic consistency checks between computed overtime values and AI-reported risk assessments, reducing the likelihood of undetected discrepancies. Additionally, the server can use AI-derived rankings or anomaly scores as additional features in subsequent computations, providing a feedback loop that improves detection of irregular patterns beyond what linear rule-based thresholds can capture.

In contrast to manual analysis in which a human operator reads attendance tables and remark texts, the system uses the neural network's ability to identify latent patterns in token sequences representing structured time-series data and remark descriptions. The generative AI model, implemented as a multi-layer transformer network, assigns different attention weights to different parts of the input, implicitly learning which combinations of long shifts, missed meals, and unusual mid-shift absences are most indicative of risk. This processing is not merely reproducing human workflow rules but introduces a non-conventional, data-driven inference mechanism that increases sensitivity to complex patterns while reducing false positives for simple threshold conditions.

In another embodiment, the server uses a locally deployed generative AI model running on dedicated hardware such as a graphics processing unit or a tensor processing accelerator. In this embodiment, the server stores model parameters in local storage and performs all inference within the same computing environment as the attendance database. This configuration further reduces network communication overhead and improves privacy because raw attendance data does not leave the local infrastructure. The same modular program architecture, including the AI-prompt generation module and AI-result integration module, is used, but calls to external network services are replaced with local function calls to the inference engine.

In yet another embodiment, the terminal incorporates a lightweight variant of the generative AI model, such as a distilled transformer model with fewer layers and parameters, stored in terminal memory. In this embodiment, the terminal can perform basic risk analysis offline using locally cached aggregated data for the most recent days, while the server continues to perform more detailed analysis on a larger model. This multi-tier deployment allows the system to maintain timely warnings even when network connectivity is intermittent, and illustrates that the technical improvements relate to the allocation and coordination of computational tasks across devices, not merely to a business workflow.

The server, terminal, and user thus cooperate to realize an integrated attendance management and analysis pipeline. The server orchestrates data acquisition from identification media and user inputs, normalization and aggregation of time-series and remark information, generation of optimized prompt sentences and structured inputs for a generative AI model, and integration of the model's analysis into concrete warnings, explanations, and recommendations. The terminal provides human-machine interfaces and real-time notifications in the workplace. The user interacts with the system through identification presentations, declarations, and remarks, enabling the system to maintain current and rich data for subsequent technical processing. Through these coordinated hardware and software mechanisms, the system yields improved computational efficiency, enhanced precision in attendance and overtime measures, reduced communication and inference load in AI integration, and increased robustness and interpretability of automated risk assessments.

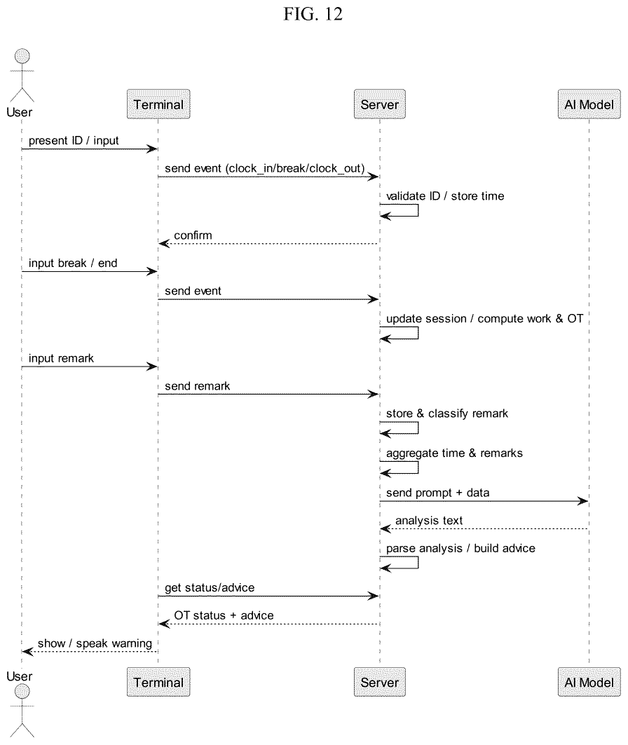

The following describes the processing flow using FIG. 12.
Step 1:

Server initializes system resources and data structures.

Server loads configuration data from a storage device, including reference working durations, overtime thresholds, and parameters for communication with a generative AI model. Server initializes a relational database by opening an attendance database file and creating tables for workers, raw time events, attendance summaries, overtime summaries, and remarks if those tables do not exist. The input to this step is static configuration data and schema definitions; the output is an initialized runtime environment in which all required tables and indices are ready for read/write operations.
Step 2:

Terminal initializes hardware interfaces and user interface.

Terminal activates an identification reading device, a display device, and an audio output device, and starts a user-interface program. Terminal loads user-interface content from the server via a network connection, such as HTML and script files, and renders screens for identification, attendance declarations, and remark inputs. The input to this step is initialization commands and content received from the server; the output is a ready state in which the terminal can detect identification media and accept user inputs.
Step 3:

User presents identification medium and starts a session.

User brings an identification medium, such as a card or tag, into proximity with the terminal's reading device and may select a “Start work” option on the screen. The input in this step is a physical action by the user and any preliminary menu selections; the output is raw identification signals captured by the terminal and a user intention to start or continue a work session.
Step 4:

Terminal reads identification information and sends it to the server.

Terminal uses a device driver for the identification reader to convert raw signals from the identification medium into digital identification information, such as an alphanumeric identifier. Terminal then constructs a structured message containing the identification information, a terminal identifier, and an event type (for example, “clock_in”). The input is the raw data from the identification reader; the output is a formatted event message transmitted to the server over a communication channel.
Step 5:

Server validates identification information and records a time event.

Server receives the event message and parses the identification information and event type. Server queries the worker table in the database to resolve the identification information to an internal worker identifier. Server obtains a current timestamp from a time source and inserts a new row into the raw time events table with columns for worker identifier, timestamp, event type, and terminal identifier. The input is the event message from the terminal; the output is a normalized time-event record stored in the database and, optionally, a confirmation message sent back to the terminal.
Step 6:

Terminal displays confirmation and updates session state.

Terminal receives the confirmation message from the server and extracts the registered time and event type. Terminal updates its internal session state to indicate that the user is now on duty or has started a new shift, and renders a confirmation message such as “Clock-in registered at 08:00” on the display. The input is the server confirmation response; the output is a human-readable notification and an updated session state that will be used in subsequent operations such as break handling.
Step 7:

User declares a break or end of work.

User operates the terminal to indicate a break start, break end, or work end, typically by pressing a corresponding button on the display. The input is the currently displayed interface and the user's intention to change working status; the output is a UI event that triggers the terminal to prepare a new attendance event to send to the server.
Step 8:

Terminal submits a break or end-of-work event to the server.

Terminal reads the active session's internal worker identifier, associates it with the event type selected by the user (for example, “break_start,” “break_end,” or “clock_out”), and attaches a local timestamp if needed. Terminal builds and transmits a structured event message to the server. The input is the UI event and session state; the output is an event message that will be processed by the server in the same normalized format as in Step 5.
Step 9:

Server updates raw time events and computes session boundaries.

Server receives the new event message, validates the worker identifier, and stores a new raw time event with the server-side timestamp in the database. Server then groups raw time events for the worker by date or shift identifier and determines the current session's work start time, break intervals, and work end time. This grouping is performed via sorting events by timestamp and pairing events of type “break_start” with subsequent “break_end” events. The input is the new event message and existing time-event records; the output is an updated event log and an implicit or explicit session structure describing the temporal boundaries of work and breaks.
Step 10:

Server calculates actual working duration and overtime duration for a session.

Server takes the session structure as input and computes a working duration as the difference between the work start time and the work end time. Server sums durations of each break interval within the session by subtracting each break start time from the corresponding break end time. Server subtracts the total break duration from the working duration to obtain the actual working duration. Server compares the actual working duration with a reference working duration stored in configuration and, if the actual working duration exceeds the reference, records the difference as session overtime. The input is the ordered set of time events for a session; the output is a set of numeric values including working duration, total break duration, actual working duration, and session overtime stored in attendance summary records.
Step 11:

Server aggregates overtime durations over a longer period.

Server periodically scans attendance summaries to compute a total overtime duration for each user over a predefined period such as a week or month. Server issues database queries to sum the session overtime values grouped by worker and period. Server writes the aggregated total overtime duration to the overtime summary table. The input is the collection of session overtime records; the output is a compact set of aggregated overtime records, each representing the total overtime duration for a worker in a given period.
Step 12:

Server generates or updates warning information based on thresholds.

Server compares each total overtime duration against a threshold duration defined in configuration data. When a total overtime duration exceeds the threshold, server creates or updates a warning record associated with the corresponding worker. Server may also compute proximity measures, such as the ratio of total overtime duration to the threshold, to classify severity levels. The input is the aggregated overtime data; the output is a set of warning flags and severity assessments that can be requested by terminals or management interfaces.
Step 13:

Terminal requests warning status and displays alerts.

Terminal sends a request to the server to obtain the current overtime status for the active user, including warning flags and severity levels. Server responds with a structured status message that includes whether the overtime threshold has been exceeded and any related textual messages. Terminal receives the status, evaluates the flag, and, if a warning is present, displays a visible alert on the screen and optionally outputs an audio warning through the audio device. The input is the overtime status message from the server; the output is multimodal feedback (visual and audio) that informs the user about overtime status.
Step 14:

User inputs remark information regarding mid-shift absences and meals.

User selects a remarks option on the terminal and types or selects information such as “Left site for customer visit from 14:00 to 15:00” or “Meal taken: No.” The input to this step is the current UI state and the user's contextual knowledge about the shift; the output is structured remark content held in terminal memory awaiting transmission to the server.
Step 15:

Terminal sends remark information to the server.

Terminal associates the remark content with the internal worker identifier and a time or session identifier. Terminal constructs a message that includes the remark text and any categorization data such as a flag indicating whether the remark relates to a mid-shift absence or a meal. Terminal then transmits this message to the server. The input is the user-entered remark and session identifiers; the output is a remark submission message sent to the server.
Step 16:

Server stores and categorizes remark information.

Server receives the remark submission message and writes a new record to the remark table, linking it via foreign keys to the corresponding worker and session. Server analyzes the remark text or categorization flags to determine whether the remark indicates a mid-shift absence, a skipped meal, or another condition. Server may apply keyword-based rules or a small classifier to map text into structured features such as “mid_shift_absence=true” or “meal_taken=false.” The input is the remark message; the output is a structured remark record and derived features stored in the database for later aggregation and analysis.
Step 17:

Server aggregates attendance, overtime, and remark data.

Server periodically or on demand executes queries that join attendance summaries, overtime summaries, and remark records by worker and period. Server constructs aggregated data that includes numerical metrics such as total actual working duration, total overtime duration, counts and durations of mid-shift absences, counts of days without meals, and any computed health-related indices. The input is the set of normalized tables in the database; the output is an aggregated data structure residing in memory or a materialized view, which consolidates all relevant metrics needed for presentation or AI processing.
Step 18:

Server generates a prompt sentence and AI input text for the generative AI model.

Server uses the aggregated data as input and formats it into structured text, for example by listing each worker's metrics in a tabular or bullet-like narrative. Server then generates a prompt sentence that describes the analysis task for the generative AI model. For example, server may generate the prompt sentence: “Given the following weekly attendance and overtime summary for each worker, identify who is at risk of exceeding 44 hours of overtime and explain any patterns in late breaks or missing meal remarks.” Server concatenates the prompt sentence and the formatted aggregated data into a single text sequence. The input is the aggregated data and predefined prompt templates; the output is a composed AI input text that is ready to be tokenized and processed by the generative AI model.
Step 19:

Server transmits the prompt sentence and data to the generative ai model and obtains an analysis result.

Server passes the composed AI input text to an inference interface for the generative AI model, which may be hosted locally or remotely. The model tokenizes the text, applies its neural network layers, and generates an output text representing an analysis. Server receives the generated text as an analysis result and verifies that it conforms to expected structural constraints, such as having identifiable sections for worker-specific recommendations. The input is the composed AI input text; the output is the analysis result text returned by the generative AI model.
Step 20:

Server integrates the AI analysis result into structured explanation and recommendation data.

Server parses the analysis result text and maps references in the text back to internal worker identifiers using pattern matching or simple name-resolution rules. Server extracts relevant statements such as “Worker A is at risk of exceeding 44 hours next week” and transforms them into structured records containing fields for worker, risk level, and recommended actions. The input is the raw analysis result from the generative AI model; the output is a set of structured explanation and recommendation records stored in a dedicated table for use by terminals and management interfaces.

### Step 21:

Terminal retrieves and displays explanation information and improvement proposals.

Terminal sends a request to the server to retrieve explanation and recommendation data for the current user or for a group of users when in supervisor mode. Server responds with the appropriate structured content. Terminal formats the content for display, for example by showing a text message such as “Based on your recent overtime and missed meal records, consider taking scheduled breaks earlier in the shift.” Terminal may also synthesize corresponding speech for audio output. The input is the structured explanation and recommendation data from the server; the output is user-facing explanations and proposals presented on the terminal's display and audio channel.
Step 22:

User reacts to warnings and recommendations and adjusts behavior or schedules.

User reads or listens to the explanations and warning messages and may alter behavior, such as taking breaks more regularly or discussing schedule adjustments with a supervisor. The input is the information presented by the terminal; the output is changed interaction patterns with the terminal (for example, more frequent break declarations) and updated attendance and remark data in subsequent sessions, which feed back into the server's computations and AI analyses.
Step 23:

Server logs events and maintains consistency across modules.

Server records each significant event—time-event insertion, remark submission, overtime aggregation, warning generation, AI prompt generation, AI analysis retrieval, and explanation delivery—in a log storage. Server periodically checks for inconsistencies, such as missing “break_end” events or mismatches between overtime summary values and raw time-event sums, and resolves or flags them. The input is the stream of operational events generated in previous steps; the output is a consistent and auditable history that supports reliability of the entire attendance management and AI-driven analysis pipeline.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional time and attendance management techniques primarily treat attendance data as static records that are manually entered, stored, and occasionally summarized. In such techniques, computing resources are mainly used as digital ledgers, and little use is made of automated, fine-grained analysis of usage patterns, user state, and contextual information such as remarks. As a result, the underlying computer systems do not fully exploit their processing capabilities to dynamically optimize how attendance information is classified, prioritized, and delivered to different organizational actors.

In particular, existing systems typically handle user-submitted attendance data and free-text remarks independently of each other, without integrated analysis that connects actual working patterns, overtime accumulation, and qualitative context such as outing reasons or meal conditions. When overtime thresholds are monitored, such monitoring is usually implemented as a simple comparison of numerical totals, without adaptively adjusting notifications or escalation paths based on a user's emotional state, the semantics of remark fields, or patterns suggesting labor conditions that may require special consideration. This leads to several technical limitations: processing pipelines remain rigid, notification behavior is coarse-grained, and server-side resources are not orchestrated to automatically identify and prioritize cases requiring managerial attention.

Moreover, in conventional implementations, generative artificial intelligence models—when used at all—are treated merely as auxiliary tools for human users, rather than as integrated components of the server-side decision logic. Prompt sentences, model outputs, and structured attendance data are not systematically combined to control how the processor classifies inputs, assigns priorities, and routes information to different endpoints such as user clients and manager notification channels. Consequently, server-side computation does not fully leverage generative models to transform unstructured text (for example, remarks on outings and meals) into structured signals that influence automated workflows.

These shortcomings result in suboptimal utilization of computing resources and network interfaces. The server often executes relatively simple aggregation and comparison routines, while leaving nuanced interpretation of remarks and escalation decisions to manual review. This increases latency in detecting problematic attendance patterns, generates unnecessary or poorly targeted alerts, and fails to provide a scalable, machine-driven mechanism for triaging cases across large numbers of users. There is thus a need for an improved computer-implemented technique that integrates declaration-based attendance data, emotional state analysis, generative artificial intelligence-based interpretation of remarks, and automated notification control, so that the processor can more intelligently classify, prioritize, and route information in real time.

The specific processing by the specific processing unit 290 of the data processing device 12 in Example 2 is realized by the following means.

The present invention provides a server comprising a processor and a memory storing instructions, wherein the processor is configured to execute the instructions to receive work-related information including declaration-based attendance data and associated remark information from a user via a communication interface; analyze the received work-related information by using a generative artificial intelligence model to classify the information into internal handling functions and to extract structured attributes from unstructured text contained in the remark information; analyze an emotional state of the user based on the work-related information and assign a processing priority to the work-related information according to an emotional analysis result; compute actual working time by subtracting break durations from working durations recorded in the attendance data and aggregate a total overtime duration for each user; compare the aggregated total overtime duration with a predetermined reference duration and, when the total overtime duration exceeds the predetermined reference duration, generate warning information and transmit the warning information to a user terminal; further analyze, by using the generative artificial intelligence model in response to a prompt sentence, outing-reason information and meal-presence information included in the remark information to classify such information into categories indicative of labor-related consideration states; generate manager-report information that combines the classified remark information, the emotional analysis result, and the overtime aggregation result, and transmit the manager-report information to a manager device via a notification medium; and perform these operations by programmatically orchestrating data retrieval from a data storage device, inference requests to the generative artificial intelligence model, and conditional routing of notifications based on computed results. This enables an improvement in computer technology by allowing the server to automatically transform heterogeneous input data into prioritized, context-aware control signals, thereby enhancing the efficiency and accuracy of attendance-related information processing, reducing unnecessary network traffic and manual review, and providing a scalable, machine-executed workflow that dynamically focuses computational and notification resources on cases requiring heightened attention.

The term “work-related information” refers to information associated with labor activities of a user, including at least attendance data, such as working-time information, break-time information, and overtime information, and contextual data, such as remark information describing outing reasons or meal conditions.

The term “communication interface” refers to a hardware and software combination that enables data exchange between a server and an external device, such as a network interface and communication protocol stack configured to send and receive digital messages.

The term “generative artificial intelligence model” refers to a data processing model implemented by software that generates or transforms data, such as text, based on learned patterns, in response to an input including a prompt sentence.

The term “internal handling functions” refers to logical or organizational functions within an entity, such as departments, roles, or processing modules, to which work-related information is assigned for further handling.

The term “emotional state” refers to a condition of a user inferred from input data, such as text content or interaction patterns, indicating affective attributes including stress, dissatisfaction, or satisfaction.

The term “emotional analysis result” refers to data produced by processing input information to estimate the emotional state of a user, typically represented as one or more labels, scores, or categories.

The term “processing priority” refers to a relative importance level assigned to work-related information, which influences scheduling, ordering, or routing of processing steps performed by a processor.

The term “declaration-based attendance management” refers to a management method in which attendance data, including working-time information and break-time information, is obtained primarily from self-declared input provided by a user rather than from automatic sensing devices.

The term “working-time information” refers to data indicating a start time and an end time of a working period during which a user is considered to be performing labor activities.

The term “break-time information” refers to data indicating at least a start time and an end time of a period during which a user is not performing labor activities within a working day.

The term “overtime information” refers to data representing a duration of labor performed beyond a standard working duration defined by a rule or policy.

The term “actual working time” refers to an effective working duration computed by subtracting one or more break durations from a total duration between a working start time and a working end time.

The term “total overtime duration” refers to an aggregated measure of overtime, typically computed over a predetermined period, such as a month, for a user.

The term “predetermined reference duration” refers to a threshold value of time, defined by a rule or configuration, against which the total overtime duration is compared.

The term “warning information” refers to notification data generated by a processor when a condition, such as the total overtime duration exceeding the predetermined reference duration, is satisfied, the notification data being intended to inform a user of such condition.

The term “remark information” refers to additional information provided by a user in association with attendance data, typically in free-text form, describing circumstances such as outings or meal conditions.

The term “outing-reason information” refers to data included in remark information that describes a reason or circumstance for a temporary absence from a workplace during a working day.

The term “meal-presence information” refers to data included in remark information that indicates whether a user took a meal during a break period.

The term “labor-related consideration state” refers to a condition relating to labor management or worker well-being, such as excessive overtime or absence of meals, which may require special attention or intervention.

The term “manager-report information” refers to information synthesized for a management role, including at least aggregated overtime results, interpreted remark information, and emotional analysis results, to support managerial decisions.

The term “notification medium” refers to a communication channel or mechanism used to deliver information from a server to a recipient device, such as an electronic messaging system or push-notification service.

The term “information processing device” refers to a computing apparatus including at least one processor and a memory, capable of executing instructions to perform data processing operations.

The term “data storage device” refers to a memory or storage apparatus, such as a database system or non-volatile storage, configured to store attendance data and related information for later retrieval and processing.

The term “prompt sentence” refers to an input expression supplied to a generative artificial intelligence model to specify a task, such as classification, summarization, or extraction, that the model is requested to perform.

The term “attendance-status summary” refers to a synthesized representation of a user's attendance condition over a period, including indicators such as total working time, total overtime duration, and notable contextual factors.

The term “classification result” refers to an output produced by a generative artificial intelligence model or other analysis logic that assigns one or more categories or labels to input data, such as outing-reason information or meal-presence information.

The term “manager device” refers to an external computing device operated by a person in a management role, configured to receive and display manager-report information.

The term “user terminal” refers to an external computing device operated by a user whose attendance is being managed, configured to transmit work-related information to the server and receive notifications.

In one embodiment, a server executes a time-and-attendance management program on general-purpose computing hardware. The server comprises at least one processor, a main memory, non-volatile storage, and a network interface. The server runs an operating system such as a Unix-like operating system and executes an application stack including a web application framework (for example, a framework of the type of Django or Flask), a relational database management system (for example, a system of the type of MySQL), a message delivery service client (for example, a client of an email delivery platform), and an application programming interface (API) client for a messaging platform (for example, a client of a chat notification service). The server further connects, via a network interface and a wide-area network, to an external generative AI model service that provides a large language model.

The terminal operates as a client device such as a smartphone, tablet, or personal computer. The terminal includes a display, an input interface, a processor, a memory, and a network interface. The terminal executes a web browser or a dedicated application. The terminal obtains user interface content, such as HTML documents, style sheets, and script code, from the server via a secure communication protocol, and renders attendance input screens, confirmation screens, and notification views. The terminal transmits user-generated data, including work-related information and prompt sentences, to the server, and receives server-generated responses.

The user operates the terminal to input work-related information. The user enters working-time information including a working start time and a working end time, break-time information including at least one break start time and break end time, and overtime information when applicable. The user also enters remark information describing outing-reason information and meal-presence information in natural language. The terminal converts these inputs into structured data conforming to predefined data structures that include an employee identifier, time fields, and free-text fields, and transmits the structured data to the server.

The server stores the received work-related information into a database managed by the relational database management system. The server uses relational tables that include fields for user identifiers, dates, working start and end timestamps, break start and end timestamps, actual working minutes, overtime minutes, and remark text. The server indexes these tables by user identifiers and date ranges to enable efficient retrieval and aggregation. The server uses an object-relational mapping component or a database driver to convert in-memory objects into SQL commands and commits transactions to ensure persistence and consistency.

The server computes actual working time and overtime by performing arithmetic operations on time data. The server normalizes time fields into a standard time zone and converts durations into integer minute values. The server subtracts break durations from total durations between working start and working end times to obtain actual working minutes for each day. The server aggregates daily actual working minutes over a predetermined period such as a month and compares the aggregate to a reference value representing the standard working minutes for that period. The server computes total overtime duration as the difference between aggregate actual working minutes and the standard working minutes, with lower bounds at zero. This numeric processing uses arithmetic units of the processor and in-memory data structures that store integer and floating-point representations of time. The server then stores the computed actual working time and total overtime duration back into the database.

The server generates warning information when the total overtime duration exceeds a predetermined reference duration. The server creates a notification object that includes user identifiers, the total overtime duration, the reference duration, and a machine-generated message body. The server passes this notification object to an email client library, which formats the content into an e-mail message. The server transmits the e-mail via an external mail service using a network protocol, thereby providing the warning information to the user at the terminal. This arrangement reduces the need for constant polling by the terminal and lowers network traffic because only state changes that cross the threshold result in outbound notifications.

The server uses a generative AI model to analyze work-related information and remark information. The server connects to a generative AI model of the type of a transformer-based neural network trained on text corpora by supervised and reinforcement learning methods. The generative AI model includes an encoder-decoder architecture or a decoder-only architecture comprising multiple attention layers, feed-forward layers, layer normalization modules, and learned token embeddings. The generative AI model receives tokenized sequences as input and produces output token sequences representing analysis results or natural language summaries.

The server converts remark information and related metadata into token sequences by applying a tokenizer that maps characters or word pieces into numerical token identifiers. The server constructs prompt sentences that specify analysis tasks for the generative AI model. For example, the server uses a prompt sentence such as: “Given the following attendance remark: ‘Left the office from 12:00 to 13:00 for a hospital visit; no meal taken,’ classify whether the outing is work-related or personal and whether a meal was taken. Return the result as plain text with clear labels.”

The server sends such a prompt sentence, together with the remark text, to the generative AI model through an API. The generative AI model processes the sequence with self-attention operations that compute weighted combinations of token embeddings based on learned query, key, and value matrices. The model propagates representations through multiple layers and generates output tokens by sampling or greedy decoding, guided by learned probability distributions. The generative AI model thereby outputs classification results such as “personal outing” and “no meal,” which the server parses into structured categories.

The server uses another kind of prompt sentence to generate attendance-status summaries for manager reporting. For example, the server uses a prompt sentence such as:

“Summarize the attendance status for an employee as follows: total working hours, total overtime hours, and notable issues based on remarks. Input data: daily working times, total overtime of 46 hours this month, and remarks including ‘Left office for hospital visit; no meal taken’on several days. Produce a concise summary for a manager.”

The server sends such a prompt sentence with structured attendance data to the generative AI model. The model applies the same neural network architecture and generates summary text that the server embeds in a manager-report information object.

The server does not rely solely on the generative AI model. The server additionally applies rule-based and statistical logic to filter and prioritize generative AI outputs. The server uses pre-defined rule sets that relate specific categories, such as “personal outing,” “no meal,” and high overtime, to different levels of escalation for manager reporting. The server combines numeric scoring based on the total overtime duration with categorical flags derived from the AI outputs, and computes composite priority scores. The server uses these scores to determine whether to send notifications via the messaging platform, to batch notifications for periodic delivery, or to suppress notifications in low-risk cases. This multi-stage processing differentiates the invention from mere automation of human review, because the processor computes and applies structured rules and weights to both numeric and textual signals in a way that is not feasible through manual inspection at scale.

The server uses a specific data structure to store analysis results from the generative AI model and the emotional analysis. The server maintains a table or record format that includes fields for sentiment scores, outing-type categories, meal-presence categories, and an overall labor-related consideration state. The sentiment scores are numeric values obtained by mapping generative AI outputs or separate sentiment models to a fixed range. The outing-type and meal-presence categories are represented by enumerated values. The labor-related consideration state is represented by a bit field or code that indicates combinations of conditions, such as “excessive overtime with repeated no-meal reports.” This structure enables efficient indexing and querying, which allows the server to rapidly identify users who require attention without scanning full text each time.

The server improves computer technology by orchestrating the generative AI model and structured data processing in a manner that reduces computation cost and communication overhead. The server uses caching for generative AI analysis results by storing the model outputs keyed by a hash of the remark text and analysis type. When the same or similar remark appears, the server can reuse prior AI outputs without querying the generative AI service again. This caching reduces external API calls and network latency, thereby improving system throughput and reducing the load on both the server and the generative AI service. The server further batches multiple analysis requests into a single call when supported by the AI API, reducing per-call overhead and improving bandwidth utilization.

The server applies a scheduling mechanism for heavy computations. The server performs initial validation and storage synchronously when receiving work-related information, but defers computationally intensive aggregation and AI analysis to scheduled jobs. The server uses a job queue or a scheduler to group multiple records and process them collectively. This reduces context-switching overhead on the processor and improves cache locality because the processor works on contiguous data segments. As a result, the time needed for monthly aggregation and analysis is reduced compared with naive record-by-record processing.

The server controls output formats and message routing in a way that reduces unnecessary network traffic and processing by the terminal. The server computes a notification profile per user based on historic overtime levels and remark patterns. When the overtime is near but not above a threshold, and no concerning remarks are detected, the server may store the status in the database without sending immediate e-mail. When the threshold is exceeded and concerning remarks are present, the server sends both an e-mail to the user terminal and a message to the manager device. This conditional behavior avoids sending trivial or redundant messages and reduces the amount of data transferred over the network, which is a computer-technical effect.

The server employs a dedicated emotional analysis component to compute an emotional analysis result. The server uses features such as word frequency, punctuation patterns, and phrase-level sentiment scores extracted from remark text and other user messages. In one embodiment, the server uses a neural network model trained for sentiment analysis, where the model includes an embedding layer, one or more recurrent or transformer layers, and a classification layer that outputs probabilities for emotional categories. The server converts these probabilities into discrete labels or continuous scores that are stored in the database and used in the priority computation. By using such features and models, the server can process large volumes of text inputs faster and more consistently than human reviewers and can identify patterns of stress or dissatisfaction that might not be apparent from raw numbers alone.

The terminal benefits from the server's architecture. The terminal does not execute heavy aggregation or AI processing. Instead, the terminal sends compact structured data and receives compact result summaries, which reduces memory and CPU usage on the terminal devices. The terminal displays key indicators such as current monthly overtime, warnings, and guidance messages. The terminal thereby remains responsive even on low-power devices, because the computational burden is offloaded to the server.

The user interacts with the system through simple interfaces and does not need to know the underlying processing. However, the technical effect arises in the way the server structures, stores, and processes the data. The server uses normalized relational tables, indexed fields, and precomputed aggregates to accelerate both user-level queries and manager-level dashboards. The server also uses event logs that capture when warnings and manager-report information were sent and how they were delivered. These logs enable offline analysis and model retraining, which can further refine thresholds and rule weights.

In a variant embodiment, the server deploys the generative AI model on-premises rather than using an external service. In such a case, the server loads the model weights into a dedicated inference engine that uses hardware acceleration, such as a graphics processing unit or a tensor processing unit. The server partitions the model into multiple segments loaded into different memory regions and performs inference by streaming token sequences through these segments. This reduces latency and reliance on external networks. The server may also compress model weights using quantization techniques to reduce memory usage and speed up matrix multiplications.

In another embodiment, the server uses multiple generative AI models specialized for different tasks. The server uses a smaller, faster model for simple classification of outing reasons and meal status, while using a larger, more capable model for generating manager summaries. The server selects which model to invoke based on the complexity of the task and the urgency of the case. This hierarchical arrangement reduces overall computation time and cost while maintaining high quality for critical outputs.

The described arrangements provide technical advantages over conventional systems that merely store and display attendance data. The server uses structured data models, specialized neural network architectures, caching strategies, batching of AI requests, and conditional notification routing to improve processing speed, accuracy of classification, and efficiency of data management. Because the server transforms heterogeneous inputs into structured control signals and uses them to automate prioritization and routing in a way that is tuned to computational and network characteristics, the system constitutes an improvement in computer technology rather than a mere automation of human judgment.

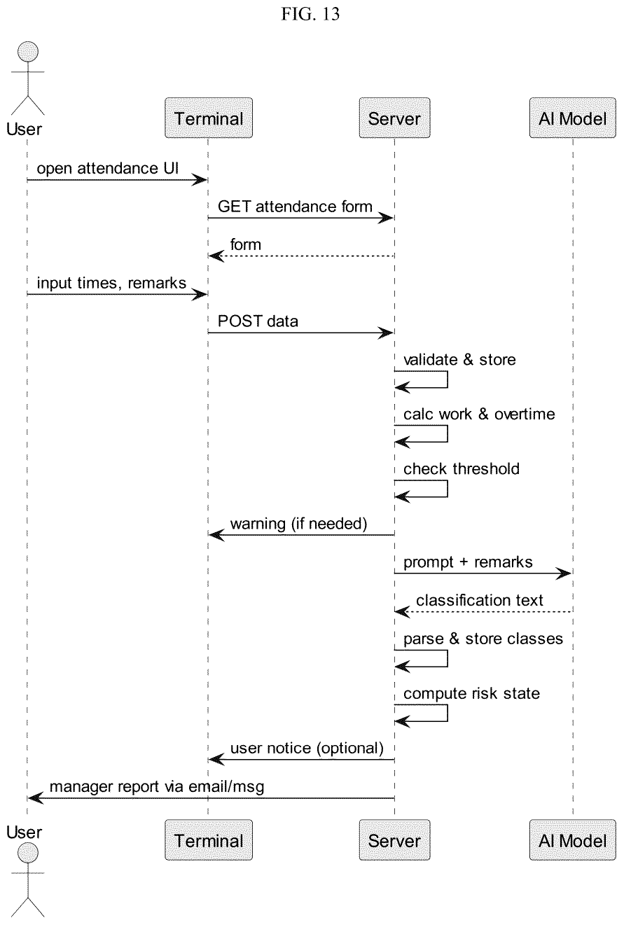

The following describes the processing flow using FIG. 13.
Step 1:

The user operates the terminal to open an attendance input screen provided by the server. The terminal sends a request to the server to obtain layout data, and the server returns screen definition data including fields for working-time information, break-time information, overtime information, and remark information.

Input: user request from the terminal to display the attendance screen.

Output: rendered input screen on the terminal based on screen definition data from the server.
Step 2:

The user operates the terminal to input a working start time, a working end time, one or more break start and end times, optional overtime information, and natural-language remarks describing outing reasons and meal conditions. The terminal locally checks the input format and time ordering.

Input: user keystrokes and touch operations on the terminal.

Output: a structured data object on the terminal containing user identifier, date, time fields, and remark text.
Step 3:

The terminal transmits the structured data object to the server via a communication interface. The terminal converts the data into a predefined request format and sends it through a secure protocol.

Input: structured attendance and remark data generated by the terminal.

Output: a network message delivered to the server containing the work-related information.
Step 4:

The server receives the network message and parses the included work-related information into internal data structures. The server validates mandatory fields, checks logical consistency of times, and normalizes time values to a standard time zone.

Input: work-related information in the network message from the terminal.

Output: validated and normalized attendance records stored in memory on the server.
Step 5:

The server stores the validated attendance records into a relational database. The server maps in-memory fields to database columns and executes insert or update operations, thereby persisting working-time information, break-time information, overtime information, and remark information.

Input: normalized attendance records in server memory.

Output: database rows representing the attendance data written to persistent storage.
Step 6:

The server computes daily actual working time by subtracting stored break durations from total durations between working start and end times. The server converts timestamps to minute counts, performs integer subtraction, and records the result as actual working minutes for each day.

Input: working-time information and break-time information retrieved from the database.

Output: calculated actual working minutes per day stored back into the database.
Step 7:

The server aggregates actual working minutes for each user over a defined period, such as a calendar month, and compares the aggregate with a standard working-time value defined by configuration data. The server subtracts the standard value from the aggregate to compute total overtime duration, applying a lower bound of zero.

Input: per-day actual working minutes for a user and reference standard working minutes for the period.

Output: total overtime duration for the period recorded as a numeric field associated with the user.
Step 8:

The server evaluates whether the total overtime duration exceeds a predetermined reference duration. The server executes a comparison operation, and when the total exceeds the threshold, the server constructs warning information containing user identification, the overtime value, and explanatory text.

Input: total overtime duration and predetermined reference duration.

Output: warning information objects in server memory identifying users who exceed the threshold.
Step 9:

The server generates and sends a warning message to the terminal associated with the user by using an external messaging service. The server formats the warning information into an e-mail or message payload and transmits it through a communication interface.

Input: warning information objects for users whose overtime exceeds the reference duration.

Output: electronic warning messages delivered to user terminals via the messaging infrastructure.
Step 10:

The user accesses the terminal to retrieve and read the warning message. The terminal obtains the message from an e-mail client or messaging application and displays the contents on the screen.

Input: electronic warning message received at the terminal.

Output: visual presentation of the warning message to the user.
Step 11:

The server performs remark analysis by sending remark information and a prompt sentence to a generative AI model. The server creates a prompt sentence that specifies a classification task for outing reasons and meal presence, concatenates the remark text, tokenizes the combined text, and submits it to the generative AI model through an API.

Input: remark text stored in the database and a task-specific prompt sentence generated by the server.

Output: generated textual output from the generative AI model describing categories such as outing type and meal presence.
Step 12:

The server converts the generated textual output from the generative AI model into structured categories. The server applies parsing rules and mapping tables to transform phrases such as “personal outing” and “no meal” into enumerated codes representing outing-reason information and meal-presence information.

Input: generative AI model output produced in response to the prompt sentence.

Output: structured classification results with discrete codes for outing type and meal status stored in the database.
Step 13:

The server analyzes an emotional state of the user based on remark information and other messages. The server applies an emotional analysis model to tokenized text, computes sentiment scores or category probabilities, and selects one or more emotional labels.

Input: text content associated with the user and model parameters for emotional analysis.

Output: emotional analysis results including scores and labels stored in association with the user records.
Step 14:

The server determines a labor-related consideration state by combining the total overtime duration, the structured classification results for remarks, and the emotional analysis results. The server applies predetermined rules and weightings to compute a composite indicator that flags potential risk conditions such as sustained high overtime with repeated no-meal reports.

Input: total overtime duration, outing-type and meal-presence codes, and emotional analysis results.

Output: a labor-related consideration state value indicating whether special attention is required for the user.
Step 15:

The server generates manager-report information when the labor-related consideration state indicates that managerial attention is needed. The server constructs report content by summarizing overtime statistics, remark classifications, and emotional indicators, optionally using a generative AI model with a dedicated prompt sentence to create a concise textual summary.

Input: labor-related consideration state and underlying analysis data for the user.

Output: manager-report information objects containing both structured metrics and textual summaries.
Step 16:

The server transmits manager-report information to a manager device via a notification medium. The server formats the report into a message payload compatible with a messaging platform, attaches identifiers for the relevant user and time period, and sends the payload through the network interface.

Input: manager-report information objects in server memory.

Output: notification messages delivered to manager devices for review.
Step 17:

The manager operates a terminal to view the manager-report information and may initiate follow-up actions. The terminal receives the notification, presents the summarized attendance status, and allows the manager to navigate to underlying details through requests to the server.

Input: report notification message received at the manager's terminal.

Output: interactive display of summarized and detailed attendance information supporting managerial decision-making.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that perform department routing of user inputs and attendance management suffer from several technical limitations. First, such systems typically treat user-provided content, attendance records, and equipment operation logs as independent data streams processed by static rule sets. As a result, the systems cannot dynamically adjust processing priority, alert thresholds, or monitoring policies based on a unified, machine-understandable representation of user state and apparatus state. This leads to inefficient use of processing resources and delayed responses to critical conditions such as excessive overtime or abnormal machine stress.

Second, known server architectures generally perform text classification and attendance calculation using fixed heuristics or simple rule-based logic executed over structured records. These architectures do not exploit generative AI models in a structured way, via explicitly constructed prompt sentences, to refine routing decisions, generate machine-readable policies, or synthesize context-aware notification messages. Consequently, the systems lack the ability to adapt their behavior to complex, changing patterns in user data and apparatus data, which degrades the overall quality and timeliness of alerts and recommendations.

Third, existing emotion recognition subsystems, when present, are usually implemented as add-on analytics that are not deeply integrated into the core resource management logic. Emotional state estimates are often logged but not used to adjust computation pathways, time thresholds, or alerting strategies in real time. This results in a technical gap: the server continues to apply uniform thresholds and static policies to heterogeneous users and workloads, preventing the system from optimally scheduling processing tasks and notifications based on predicted risk or urgency.

Fourth, conventional apparatus monitoring solutions typically analyze operation-state information and sensor information separately, without combining cumulative operating time and a computed stress index into a single, machine-usable abnormality metric. The lack of integrated computation over both time-series utilization data and multi-dimensional sensor signals prevents these systems from accurately and early detecting potential failures, and forces operators to manually correlate disparate dashboards, which is both error-prone and computationally inefficient.

Fifth, the communication layer in traditional systems offers only simple, single-channel alerts (for example, email only) triggered by fixed thresholds. There is no technical framework for escalating notifications across multiple communication means depending on dynamically computed risk levels that incorporate overtime, emotion, and apparatus stress. This limits the system's ability to allocate network and processing resources preferentially to high-risk events and to ensure timely human attention to critical conditions.

Accordingly, there is a need for an improved computer-implemented system and server architecture that: (i) unifies user information, emotion estimates, attendance data, and apparatus monitoring data within a single processing flow; (ii) programmatically constructs prompt sentences for generative AI models to obtain higher-level analyses, policy designs, and message templates; (iii) computes, stores, and applies dynamic thresholds for overtime and apparatus stress based on emotional state and sensor-derived numerical indices; and (iv) orchestrates multi-channel alerting and automated proposal generation in a way that improves the accuracy, responsiveness, and scalability of the underlying information processing technology.

The specific processing by the specific processing unit 290 of the data processing device 12 in Application Example 2 is realized by the following means.

The present invention provides a server comprising a processor and a memory storing instructions that, when executed by the processor, cause the server to receive activity information and attendance information from a user via a client device; to construct a prompt sentence for a generative AI model based on at least a portion of the received information and to transmit the prompt sentence to the generative AI model and receive an analysis result; to classify the received information into a processing entity on a business unit basis or an organizational unit basis in accordance with the analysis result; to estimate an emotional state of the user based on input information and sensing information related to the user and to store an emotional analysis result; to record attendance information based on self-reported data from the user; to calculate, based on the recorded attendance information, a total working time and a total overtime working time in a predetermined period; to determine whether the calculated total overtime working time exceeds a reference time; to analyze remark information input by the user using a natural language processing function to extract at least an interruption reason, an external leaving status, and a meal status, and to structure the extracted information as attendance information; to change the reference time for overtime working time or a warning condition based on the stored emotional analysis result so that the reference time is dynamically adjusted per user; to acquire operation-state information and sensor information from an apparatus; to calculate an operating time of the apparatus in a predetermined period based on the operation-state information and to calculate, based on the sensor information, a numerical index representing a load state or a stress state of the apparatus; to detect an abnormal state of the apparatus when the operating time exceeds a predetermined time or when the numerical index exceeds a predetermined threshold; to generate a prompt sentence requesting the generative AI model to generate a design or an improvement proposal for at least one of an attendance management policy and an apparatus monitoring policy and to use a result generated by the generative AI model as setting information or as a template of a notification document; and to control transmission of warnings or proposals via one or more communication means based on at least the dynamically adjusted reference time, the emotional analysis result, and the numerical index. This enables the computer system to improve internal scheduling and prioritization of processing tasks, to adapt threshold values and alerting behavior automatically in response to predicted user risk and apparatus stress, to reduce manual rule-tuning, and to provide more timely and context-aware notifications and policy updates, thereby enhancing the overall performance and technical capabilities of server-based attendance management and apparatus monitoring.

The term “activity information” refers to information indicating actions performed by a user, including at least one of work tasks, interaction events with a system, or operation instructions relating to an apparatus.

The term “attendance information” refers to time-related information for managing work status of a user, including at least a work start time, a work end time, a break time, a working date, and an overtime working duration.

The term “prompt sentence” refers to a text sequence constructed by the system for input to a generative AI model, the text sequence specifying at least an analysis request, a design request, or a message-generation request.

The term “generative AI model” refers to a machine learning model capable of generating text or other structured outputs in response to an input prompt sentence, the model being trained on large-scale data and used as an external analysis or synthesis engine.

The term “analysis result” refers to information output from the generative AI model in response to a prompt sentence, including at least classification information, routing information, policy suggestions, or natural-language descriptions.

The term “processing entity” refers to a logical or physical unit that processes information within an organization, including at least one of a business division, an organizational department, a service team, or a processing queue.

The term “emotional state” refers to a state representing psychological or affective conditions of a user, such as stress, fatigue, satisfaction, or frustration, estimated based on at least one of input behavior, biometric information, or sensing information.

The term “sensing information” refers to information acquired from one or more sensors associated with the user, including at least one of image data, audio data, motion data, or input-speed data.

The term “emotional analysis result” refers to data indicating a classification or a score of an emotional state of a user, which is generated by an emotion estimation function based on sensing information and input information.

The term “management criterion” refers to a parameter or rule used by the system to control processing of user-related operations, including at least a threshold for overtime, a warning condition, a review frequency, or a routing priority.

The term “self-reported data” refers to attendance information or remark information that is manually input by the user through an interface without automatic measurement by hardware sensors.

The term “total working time” refers to an aggregated duration of working periods of a user in a predetermined time window, excluding designated break times.

The term “total overtime working time” refers to a portion of the total working time that exceeds a predefined standard working time for the predetermined time window.

The term “reference time” refers to a threshold value of working time or overtime working time used by the system for comparison to determine whether to generate an alert or to change a management action.

The term “remark information” refers to free-text or semi-structured text input by the user in association with an attendance record, the text describing at least an interruption reason, movement, meal status, or subjective comments.

The term “natural language processing function” refers to a software component or algorithm that analyzes text data to perform at least tokenization, part-of-speech tagging, phrase extraction, classification, or keyword detection.

The term “interruption reason” refers to a classified cause of temporary suspension of work by the user, such as external errands, meetings, rest, or personal tasks, which is extracted from remark information.

The term “external leaving status” refers to information indicating whether the user temporarily left a work site or facility during a working period, as determined from remark information or other data.

The term “meal status” refers to information indicating whether the user consumed a meal, skipped a meal, or took a specific type of meal during a working day or break period.

The term “dynamically adjusted reference time” refers to a reference time value that is changed by the system during operation based on at least the emotional analysis result, user history, or system policies, rather than remaining fixed.

The term “work apparatus” refers to any physical equipment used for performing work operations, including at least a production device, a tool, a machine, or a robot installed in a working environment.

The term “machine apparatus” refers to a physical machine or automated device that performs mechanical, electrical, or electronic operations, including but not limited to industrial robots, manufacturing equipment, and automated conveyors.

The term “operation-state information” refers to status information of an apparatus, including at least a running state, an idle state, an error state, a cycle count, an on/off state, or a mode of operation.

The term “sensor information” refers to measurement values acquired from one or more sensors associated with an apparatus, including at least temperature, vibration, current, voltage, sound level, or positional data.

The term “operating time” refers to a cumulative duration during which an apparatus is determined to be in an active operating state within a specified time period.

The term “numerical index” refers to a scalar value computed from sensor information or other apparatus data that represents a quantitative measure of a load state or a stress state of an apparatus.

The term “load state” refers to a condition of an apparatus corresponding to applied workload, usage intensity, or operational burden, quantified by the numerical index.

The term “stress state” refers to a condition of an apparatus indicative of fatigue, abnormal strain, or elevated risk of failure, inferred from trends and patterns in sensor information and represented by the numerical index.

The term “abnormal state” refers to an operational condition of an apparatus or user-related metric that deviates from a normal range defined by one or more thresholds, such as excessive operating time, high stress state, or irregular patterns.

The term “warning condition” refers to a set of logical criteria used by the system to decide when to generate and transmit a warning, the criteria including at least comparisons between measured values and a reference time or a threshold.

The term “communication means” refers to a communication channel or mechanism used to transmit information from the server to a recipient, including at least electronic mail, short message service, push notification, or in-application messaging.

The term “maintenance plan” refers to a schedule or set of actions for inspecting, repairing, or adjusting an apparatus based on its operating time and stress state.

The term “labor plan” refers to a schedule or set of actions for allocating, limiting, or redistributing human work resources based on attendance information, emotional state, and overtime metrics.

The term “setting information” refers to configuration data used by the system to control processing behavior, including at least thresholds, policy parameters, routing rules, and template selections.

The term “notification document” refers to a message body or formatted content transmitted to a user or manager, including at least warnings, recommendations, summaries, and policy explanations.

The term “template of a notification document” refers to a parametrized text structure generated or refined by the generative AI model and stored by the system for later instantiation with specific values such as times, names, or thresholds.

The term “policy” refers to a set of rules, thresholds, and procedures used by the system for controlling attendance management, apparatus monitoring, routing decisions, or alerting behaviors.

In one embodiment, a server, a terminal, and a user cooperate to implement the claimed system. The server includes at least one processor, a main memory, a non-volatile storage device, and network interfaces. The terminal includes at least one processor, a display, an input device, a camera, a microphone, and a network interface. The user operates the terminal to input information. The server executes multiple software modules that implement attendance management, apparatus monitoring, emotion estimation, natural language processing, and interaction with a generative AI model using prompt sentences.

The server uses an operating system, such as a general-purpose server operating system, and executes middleware such as a web server, an application server, and a database management system. The server uses a relational database system, such as a generic SQL-compatible database, to store attendance records, emotion records, apparatus sensor data, stress indices, thresholds, alert logs, and generative AI outputs. The server further executes an application layer implemented, for example, in a high-level programming language such as a general-purpose scripting language or a virtual machine language, using frameworks analogous to web application frameworks for request handling and object-relational mapping.

The terminal runs client-side software, such as a web browser or a native application, implemented with a user interface framework. The terminal uses platform APIs to access the camera and the microphone. The terminal executes a lightweight emotion engine to pre-process image and audio signals and to generate intermediate features for the server-side modules.

The server stores attendance information in normalized database tables. For example, the server stores a user identifier, a date, a start time, an end time, and one or more break intervals in an attendance table. The server stores remark information in a separate text column linked by a foreign key. The server stores apparatus state transitions and sensor readings in time-series tables indexed by apparatus identifier and timestamp. The server maintains an emotion table that records, for each user and time interval, an emotion label (such as “tired”, “stressed”, “neutral”) and a confidence score in a floating-point field.

The server executes an emotion estimation module that processes sensing information. In one embodiment, the terminal acquires a sequence of facial images with the camera while the user inputs attendance information. The terminal applies a convolutional neural network (CNN) to each frame to obtain an embedding vector for the user's facial expression. The CNN can have multiple convolutional layers with rectified linear activation functions, pooling layers, and fully connected layers producing a fixed-length feature vector. The terminal transmits the embedding vector, instead of raw image data, to the server to reduce network load. The server receives the embedding vector and applies a classifier network, for example a shallow neural network or a logistic regression layer, to compute probabilities for multiple emotion categories. The server selects the category with the highest probability as the emotion label and uses the probability as the confidence score.

The terminal also uses the microphone to capture short audio segments during user interaction. The terminal computes acoustic features such as Mel-frequency cepstral coefficients (MFCCs), pitch contour, intensity statistics, and speech rate. The terminal sends these features to the server. The server applies a recurrent neural network or a temporal convolution network over the sequence of acoustic feature vectors to estimate an additional emotion distribution. The server then combines facial and acoustic emotion distributions using a weighted average or a learned fusion layer. This fusion yields an emotional analysis result with improved robustness over single-modality detection.

The server implements a natural language processing module for remark information. The server receives free-text remark information from the terminal and stores the raw text. The server applies tokenization, part-of-speech tagging, and dependency parsing using an NLP library. The server then applies a rule-based pattern matcher and a statistical classifier to the parsed structure to detect phrases related to external leaving status and meal status. For example, the server uses hand-crafted patterns that match verbs indicating leaving or eating, combined with time expressions and negations. The server also uses a supervised classifier, trained on labeled remark samples, to assign labels such as “external break present” and “meal skipped”. The output labels are written back into structured boolean or categorical columns. This combination of structured data and free text reduces database complexity and enables efficient aggregation queries.

The server performs attendance computation using a combination of SQL aggregation and in-memory arithmetic. The server retrieves all attendance records for a user within a predetermined period. The server sorts the records by date and computes a daily working time by subtracting break intervals from the difference between end time and start time. The server then accumulates daily working time across the period to obtain total working time and total overtime working time, where overtime is defined as work exceeding a standard daily duration. The server stores the computed totals in an overtime summary table with indexes on user identifier and period. These precomputed summaries allow the server to answer queries and generate alerts with low latency, improving response time as compared to recomputing totals on every request.

The server implements a dynamic threshold engine that adjusts reference times and warning conditions based on the emotional analysis result. The server maintains a policy table with default reference times for overtime, and an override table storing per-user adjustments. When the server updates the emotional state for a user, the server evaluates rules such as: when the emotion label is “tired” or “stressed” and the confidence score exceeds a threshold, reduce the overtime reference time by a specified quantity. The server writes the adjusted reference time into the override table with a validity period. When the server later compares total overtime working time against a reference time, it first checks the override table. This structure allows each user to have a distinct, dynamically updated reference time, without changing global policy constants. This yields a technical effect of fine-grained control over alert generation at runtime, reducing false negatives for users under stress and reducing unnecessary alerts for users not under stress.

The server executes an apparatus monitoring module that communicates with work apparatuses or machine apparatuses using industrial communication protocols. The server periodically polls operating-state information, such as start/stop flags, error codes, and cycle counters. The server also collects sensor information including vibration amplitude, temperature, and electric current. The server stores these streams in time-series tables optimized with indexes on apparatus identifier and timestamp and, in some embodiments, compressed time-series storage. The server computes operating time by detecting transitions from idle to active state and summing intervals of active state. This event-based calculation reduces errors compared to naive sampling because the server uses precise timestamped events from control systems.

The server calculates a numerical index representing an apparatus stress state. In one embodiment, the server uses a neural network model that receives a window of recent sensor values as input. The input consists of normalized vibration spectra, temperature gradients, and counts of minor error events over the window. The neural network uses convolutional layers over the time dimension to detect characteristic patterns indicating bearing wear, misalignment, or overload. The final layer outputs a scalar stress score between 0 and 1. The model is trained offline using historical apparatus data and labels indicating whether a period preceded a failure event. The server deploys the trained model and executes it periodically over sliding windows of sensor data. The server stores the resulting stress score in a machine stress table. By using time-series convolution and learned weights, the server can capture subtle correlations across multiple sensor channels that human operators or simple thresholds cannot detect, thereby improving prediction accuracy and reducing false alarms.

The server combines operating time and stress score to detect abnormal states. For example, the server defines an abnormal state when the operating time exceeds a first threshold or when the stress score exceeds a second threshold. In some embodiments, the server computes a combined risk score as a weighted sum or a more complex function of normalized operating time and stress score. By combining normalized metrics, the server avoids the limitation of single-parameter monitoring and can trigger earlier warnings before parts fail. This combination also enables prioritization when multiple apparatuses are monitored: the server sorts apparatuses by risk score and allocates maintenance resources accordingly.

The server interacts with a generative AI model by constructing explicit prompt sentences. The server uses a prompt construction module that takes as input system context such as current policies, recent failure statistics, and attendance patterns. The server formats this context into a textual prompt that follows a predefined structure. For example, the server generates a prompt sentence of the form:

“Design a monitoring policy for factory machines that currently use a 40-hour weekly operating time limit and a machine stress threshold of 0.7. Propose how to adjust these thresholds dynamically based on recent failure occurrences and variance in sensor measurements.”

The server transmits this prompt sentence to a generative AI model endpoint using a standard network protocol, receives the generated response, and parses the response to extract suggested threshold adjustments or explanation text. The server does not directly apply all suggestions; instead, the server stores them in a design suggestion table and exposes them to administrators via a dashboard. This architecture ensures that the generative AI model is used as a design-time and configuration-time assistant, improving the quality and speed of policy development. The use of structured prompt sentences and storage of responses in a formal data structure also allows the server to reuse portions of the suggestions in future automated reasoning, without re-contacting the generative AI model each time.

The server further uses a generative AI model to generate notification document templates. For example, the server constructs a prompt sentence such as:

“Generate a polite but firm email message warning an employee that the monthly overtime has exceeded the adjusted limit of 40 hours due to detected fatigue, and recommend taking additional rest and consulting a manager.”

The server receives a candidate message body from the generative AI model, then inserts runtime values, such as the actual overtime hours and dates, using parameter substitution. The server caches the generated templates in a template repository, keyed by scenario identifiers. This caching reduces the number of generative AI calls and decreases latency and network traffic when generating alerts.

The server uses efficient data structures and algorithms to reduce computational overhead. For example, the server maintains materialized views or precomputed aggregate tables for overtime summaries and apparatus utilization. By updating these aggregates incrementally as new records arrive, the server avoids scanning entire historical tables for each alert calculation. The server also uses indexing on user identifiers, apparatus identifiers, and date ranges to speed up retrievals. These techniques provide a concrete improvement in processing speed and scalability over naive implementations that recompute all aggregates in response to each request.

The server's integration of emotion-aware threshold adjustment provides a technical improvement over human-only systems. Human administrators may periodically adjust policies manually; however, they cannot react in real time to every detected pattern. The server automatically updates reference times and alert conditions based on computed emotion and stress metrics. Because these metrics are derived from multi-modal signals and machine-learned models, the adjustments are based on quantitative, high-resolution data not available to humans in practice. As a result, the server can prevent overload conditions earlier and with fewer false positives, reducing the amount of wasted maintenance work and unnecessary user interruptions.

The terminal contributes to technical effects by performing pre-processing and feature extraction near the data source. By computing facial embeddings and acoustic features on the terminal and sending only compact feature vectors to the server, the system reduces network bandwidth requirements and latency. This edge processing also reduces privacy risk, because raw image and audio data can be discarded at the terminal after conversion to embeddings. The distributed design thus improves communication efficiency and supports large-scale deployment across many terminals.

The user interacts with the system through intuitive interfaces, but the underlying processing is non-trivial and non-conventional. The system does not simply automate manual attendance calculation; rather, it uses emotion-aware policies, time-series stress analysis, and generative AI-assisted configuration to dynamically tailor computational control logic and communication patterns. The server modifies which data it fetches, which alerts it generates, and how it routes information based on machine-learned internal states, not merely replicating human decision trees.

In another embodiment, the server uses alternative machine learning architectures. For example, the emotion classifier can use a transformer-based model that takes as input a sequence of tokenized transcribed text from user remarks, combined with continuous features representing typing speed and error rate. The apparatus stress model can use gradient-boosted decision trees on engineered features such as rolling standard deviation of vibration or normalized frequency of low-level error codes. The generative AI interaction can use an internal generative language model hosted by the same organization, rather than an external service, with fine-tuning on domain-specific corpora. These variations show that the claimed system is not limited to a particular vendor implementation but can be realized with any model architecture that supports the described functionality.

In a further embodiment, the server incorporates a policy optimization loop. The server periodically evaluates the performance of its alerting policies by comparing predicted risk scores and generated alerts with actual outcomes, such as machine failures or user health incidents. The server uses this evaluation to adjust weights in the risk score calculation and to regenerate updated prompt sentences for the generative AI model. By closing this feedback loop, the system continuously improves accuracy and timeliness of alerts.

In another embodiment, the server deploys different configurations for different environments. For office environments with minimal apparatus monitoring, the server disables apparatus stress analysis and focuses on attendance and emotion. For factory environments, the server emphasizes apparatus monitoring and integrates attendance patterns of operators with apparatus risk to suggest reallocation of staff. Because the core data structures (attendance tables, emotion tables, apparatus data tables) are shared across these scenarios, the server can reuse modules and scale horizontally.

The system also provides technical improvements in data management. By structuring unstructured remark information and generative AI suggestions into normalized tables with explicit schemas, the server allows queries that combine structured and unstructured semantics. For example, the server can query “all days where a user skipped lunch and was classified as stressed with probability greater than 0.8” without scanning raw text. Likewise, the server can search for all generative AI policy suggestions mentioning a certain threshold change and correlate them with subsequent failure rates, enabling data-driven policy decisions.

Overall, the server, the terminal, and the user together realize a computer-implemented system that improves technical aspects of information processing, including processing speed, accuracy of emotion and stress detection, efficiency of communication, and flexibility of policy management. The use of specific machine learning architectures, structured prompt sentences for generative AI models, and optimized data structures yields concrete technical effects that extend beyond abstract business concepts and provide an improved computer system for attendance management and apparatus monitoring.

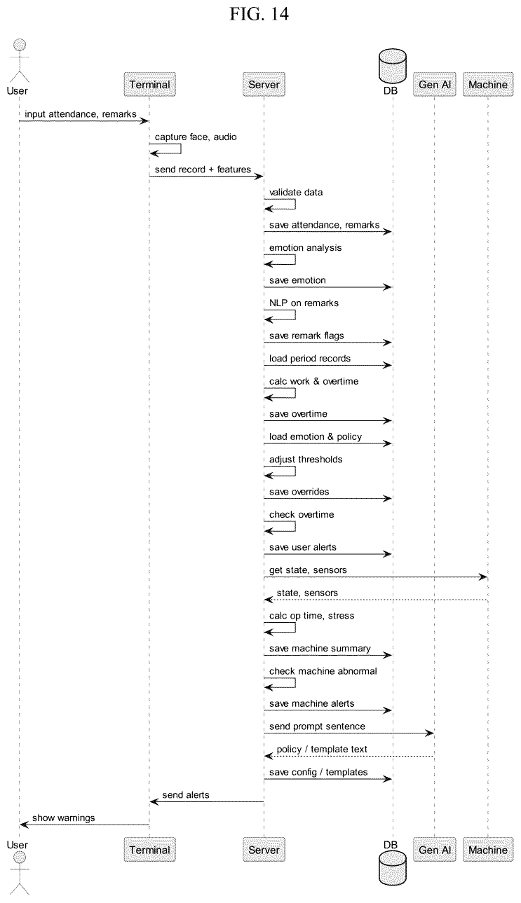

The following describes the processing flow using FIG. 14.
Step 1:

User operates the terminal to input attendance and remark information.

User opens an attendance input screen on the terminal and enters a work start time, a work end time, one or more break intervals, an apparatus identifier (if applicable), and free-text remark information.

Input: raw key presses, touch events, and voice input on the terminal.

Terminal converts these inputs into structured values (time stamps, identifiers, and text strings) using local validation logic (for example, checking time format “HH: MM” and ensuring mandatory fields are filled).

Output: a structured attendance record object containing fields such as user_id, date, start_time, end_time, break_list, apparatus_id, and remark_text.
Step 2:

Terminal acquires sensing information for emotion estimation.

Terminal activates a camera and a microphone, captures a sequence of facial images and short audio segments while the user is entering information, and converts these raw signals into numerical features.

Input: raw image frames, raw audio samples, and a time window corresponding to the user interaction period.

Terminal applies a convolutional neural network to each frame to obtain a facial embedding vector, and computes acoustic features such as MFCCs, pitch statistics, and speech rate from the audio.

Output: a feature packet containing facial embedding vectors, acoustic feature vectors, and timestamps, linked to the structured attendance record object.
Step 3:

Terminal sends structured data to the server.

Terminal aggregates the attendance record object and the feature packet, serializes them into a message (for example, JSON), and transmits the message to the server via a secure network protocol.

Input: the structured attendance record object and the feature packet created at the terminal.

Terminal places these data into a request body with fields like “attendance”, “emotion_features”, and “metadata”, then opens a network connection and sends the request.

Output: a network message delivered to the server containing attendance information and pre-processed emotion features.
Step 4:

Server receives and validates the incoming data.

Server accepts the network message, parses the serialized content, and checks consistency of the data fields.

Input: the network message containing the attendance structure and the feature packet from the terminal.

Server verifies that the start_time is earlier than the end_time, checks that recorded breaks lie within the working interval, confirms that the apparatus_id (if present) exists in an apparatus master table, and ensures that required identifiers are not null. Server discards or flags records failing validation and logs errors.

Output: a validated attendance record structure and a validated feature packet, or an error response sent back to the terminal.
Step 5:

Server stores attendance and remark information in the database.

Server maps the validated attendance structure to one or more rows in relational tables and writes them into persistent storage.

Input: the validated attendance record structure including user_id, date, start_time, end_time, break_list, and remark_text.

Server converts date and time strings into internal timestamp formats, splits break_list into separate break records, and inserts rows into attendance, break, and remark tables using database insert operations.

Output: persisted attendance, break, and remark records identified by primary keys and linked by foreign keys.
Step 6:

Server processes emotion features and estimates the user's emotional state.

Server receives the facial embedding vectors and acoustic feature vectors and applies machine learning models to compute emotion probabilities.

Input: the feature packet containing a sequence of facial embedding vectors and acoustic feature vectors associated with the user and the attendance record.

Server feeds facial embeddings into a classifier network to obtain a probability distribution over labels (“neutral”, “tired”, “stressed”, etc.), feeds acoustic features into a temporal model to obtain a second distribution, and fuses these distributions using a weighted combination. Server selects the label with the highest combined probability as the emotion label and records the probability value as a confidence score.

Output: an emotion analysis result consisting of an emotion_label and an emotion_score associated with the user_id and the attendance record.
Step 7:

Server stores the emotion analysis result.

Server writes the estimated emotional state into an emotion table and links it to other user data.

Input: the emotion_label, emotion_score, user_id, and a reference to the attendance record.

Server creates a new entry in the emotion table with columns for user_id, attendance_id, label, score, and timestamp, and uses an insert operation to persist the record.

Output: a persisted emotion entry that can be queried and joined with attendance and remark records.
Step 8:

Server analyzes remark information using natural language processing.

Server processes the free-text remark_text to extract structured attributes such as interruption reason, external leaving status, and meal status.

Input: the remark_text string associated with the attendance record and stored in the remark table.

Server tokenizes the text, assigns part-of-speech tags, identifies phrases with a dependency parser, and applies pattern rules and a trained classifier to detect whether the user left the workplace, whether the user ate a meal, and what the stated reason for interruption is. Server then maps these detections to categorical or boolean fields.

Output: structured remark attributes such as interruption_reason_code, external_leaving_flag, and meal_flag, which are written back to the database as updated columns or linked records.
Step 9:

Server computes daily and period-based working times.

Server derives working durations for each attendance record and aggregates them over a predetermined period such as a week or a month.

Input: attendance records for a given user, including start_time, end_time, and break intervals for each day in the period.

Server computes daily working time by subtracting total break duration from the difference between end_time and start_time, then sums these daily working times across all days in the period. Server also computes overtime by subtracting the standard working duration (for example, 8 hours per day) from each daily working time where applicable and summing only the positive differences.

Output: numerical values for total working time and total overtime working time for the user in the specified period.
Step 10:

Server adjusts reference times based on emotional state.

Server modifies overtime reference thresholds when the user's emotional state indicates stress or fatigue.

Input: the total overtime working time, the default reference time for overtime, and the latest emotion_label and emotion_score for the user.

Server evaluates rule conditions such as “if emotion_label is ‘tired’ or ‘stressed’ and emotion_score >0.7 then reduce the reference time by 4 hours”, updates or inserts a per-user reference time into a policy override table, and marks the modified threshold as active for the current and upcoming periods.

Output: an adjusted reference_time value for the user and a corresponding policy override record stored in the database.
Step 11:

Server detects overtime violation and creates alerts.

Server determines whether the user's overtime exceeds the (possibly adjusted) reference time and, if so, generates one or more alert records.

Input: the total overtime working time for the user in the period and the current reference_time resolved from the default policy and any overrides.

Server compares total overtime working time against reference_time, and when the overtime is greater, computes the overage amount (difference between overtime and reference_time), assigns an alert severity level, and inserts an alert row into an alert table with fields for user_id, period, overage_amount, severity, and status.

Output: one or more alert records representing overtime violations to be processed by the notification subsystem.
Step 12:

Server acquires apparatus operation-state information and sensor information.

Server communicates with each apparatus to retrieve current state and sensor readings.

Input: a list of apparatus identifiers and connection parameters for industrial communication interfaces.

Server opens connections to each apparatus, queries operating-state flags (running, idle, error), reads counters (cycle counts, runtime counters), and samples sensor channels (vibration, temperature, current). Server timestamps each sample and associates it with the corresponding apparatus_id.

Output: a time-stamped apparatus data set containing operating-state information and sensor information, which is appended to apparatus state and sensor tables.
Step 13:

Server calculates apparatus operating time and stress index.

Server processes apparatus data to determine cumulative operating time and to compute a numerical stress index.

Input: the time-stamped operating-state information and the stored sensor time series for each apparatus over a target window.

Server identifies contiguous intervals where the state is “running” and sums their durations to obtain operating_time for the window. Server selects sensor data segments in the same window, normalizes sensor values, and feeds them into a stress model (for example, a neural network) that outputs a scalar stress_index between 0 and 1, representing the apparatus stress state.

Output: operating_time and stress_index values for each apparatus and window, stored as fields in an apparatus summary table.
Step 14:

Server detects apparatus abnormal state and generates apparatus alerts.

Server determines whether apparatus usage or stress exceeds configured thresholds and creates alerts for maintenance.

Input: the computed operating_time and stress_index for each apparatus, along with configured thresholds for operating_time and stress_index.

Server compares operating_time with an operating_time_threshold and stress_index with a stress_threshold, and determines that an apparatus is abnormal when at least one threshold is exceeded. Server calculates a risk score (for example, a weighted combination of normalized operating_time and stress_index), assigns an alert priority based on this risk score, and inserts a maintenance alert into the alert table with apparatus_id, risk score, and recommended action codes.

Output: apparatus alert records that identify apparatuses requiring inspection or schedule adjustment.
Step 15:

Server constructs prompt sentences for interaction with a generative AI model.

Server generates textual prompts to request policy suggestions or notification templates.

Input: current policy parameters (reference times, thresholds), recent performance metrics (number of alerts, failure occurrences), and use-case identifiers (such as “policy redesign” or “alert email template”).

Server formats this information into a prompt sentence, for example: “Design a monitoring policy for factory machines that currently use a 40-hour weekly operating time limit and a machine stress threshold of 0.7. Propose how to adjust these thresholds dynamically based on recent failure occurrences and variance in sensor measurements.”

or

“Generate a polite but firm email message warning an employee that the monthly overtime has exceeded the adjusted limit of 40 hours due to detected fatigue, and recommend taking additional rest and consulting a manager.”

Server sends the constructed prompt sentence to a generative AI model endpoint and receives a text response.

Output: a generative AI response text containing policy suggestions or notification language.
Step 16:

Server stores and utilizes generative AI responses.

Server parses and persists the generative AI response and applies it as configuration or template data when appropriate.

Input: the response text produced by the generative AI model in reply to the prompt sentence.

Server extracts relevant values such as proposed threshold adjustments or recommended message structure, stores the full response text in a design_suggestion or template table with associated context metadata, and flags entries that are approved by administrators. When generating alerts or updating policies, server retrieves the approved entries and applies them as setting information or as template text, inserting dynamic values such as user names, dates, and measured times.

Output: updated policy configuration records and reusable notification templates derived from the generative AI responses.
Step 17:

Server dispatches alerts and notifications through multiple communication means.

Server sends warnings and proposals to users and managers based on alert records and configured templates.

Input: alert records for overtime and apparatus abnormalities, the associated user or apparatus identifiers, and the notification templates (either predefined or generated by the generative AI model).

Server selects communication channels (for example, email, SMS, push notification) according to alert severity, populates the chosen template with runtime parameters (such as total overtime, adjusted reference time, or apparatus risk score), and sends formatted messages via appropriate communication interfaces.

Output: delivered notifications to terminals or other devices, resulting in user-visible alerts that reflect computed overtime, emotional state, and apparatus stress conditions.
Step 18:

Terminal presents alerts and recommendations to the user.

Terminal receives incoming notifications from the server and displays them in an organized manner.

Input: notification messages received through email, SMS, or in-application push channels, containing alert content and recommendation text.

Terminal extracts key fields such as alert type, severity, and recommended actions, and renders them in the user interface. Terminal may allow the user to acknowledge alerts, request additional information, or initiate follow-up actions, and sends such responses back to the server as structured events.

Output: user-visible alert screens and user responses, which close the loop between server-side computations and user actions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

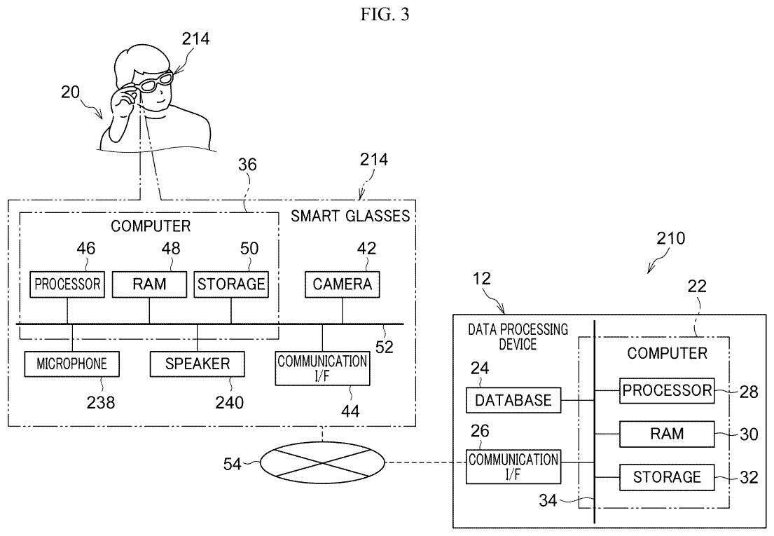

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

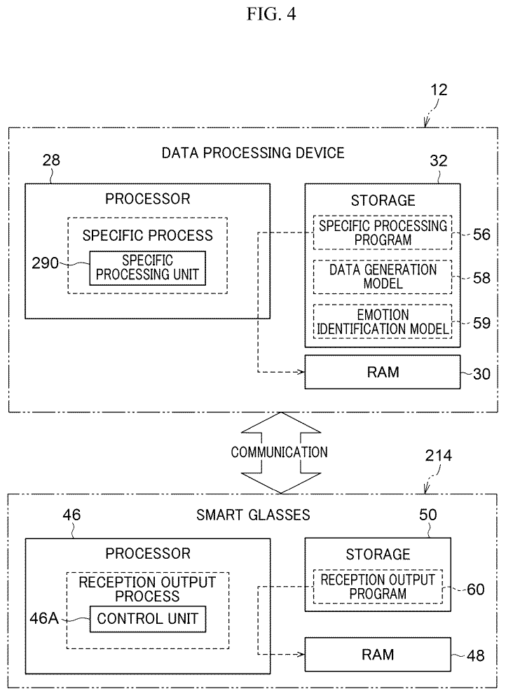

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

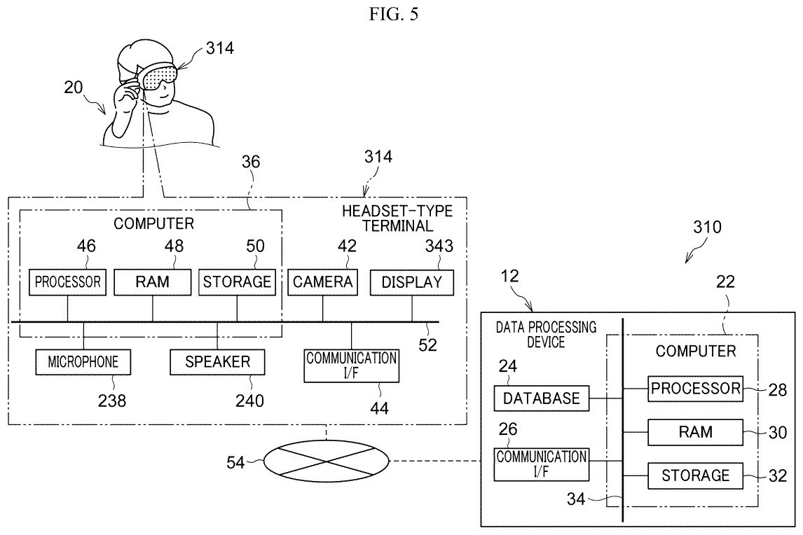

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

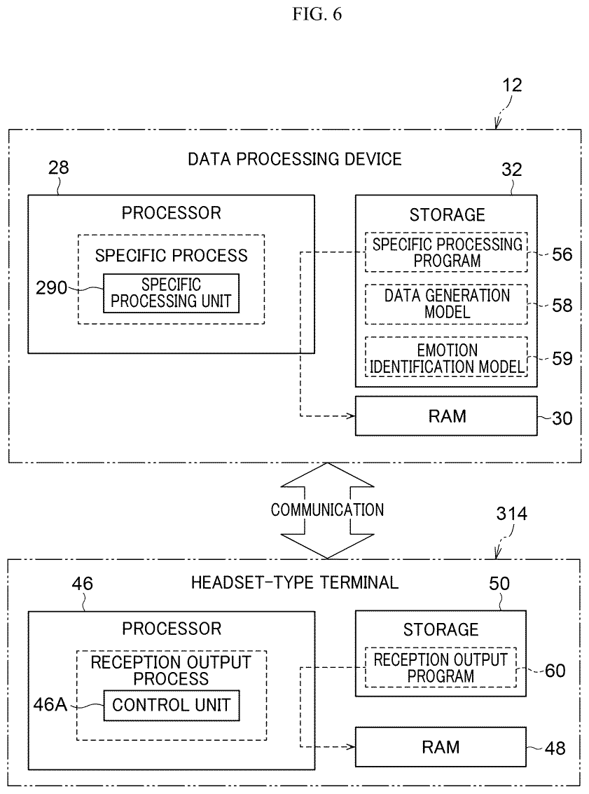

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

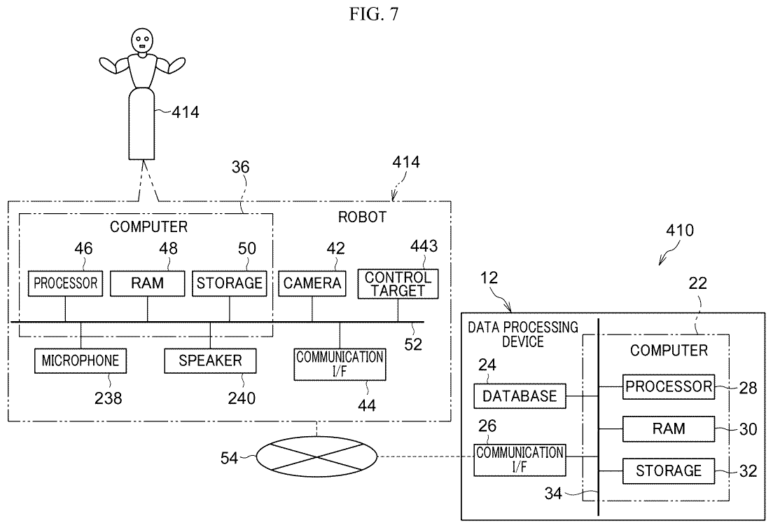

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

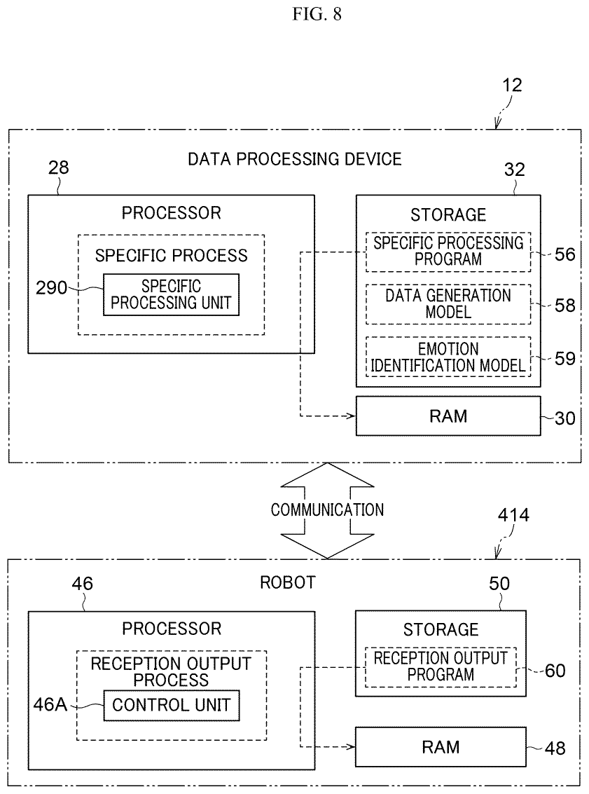

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

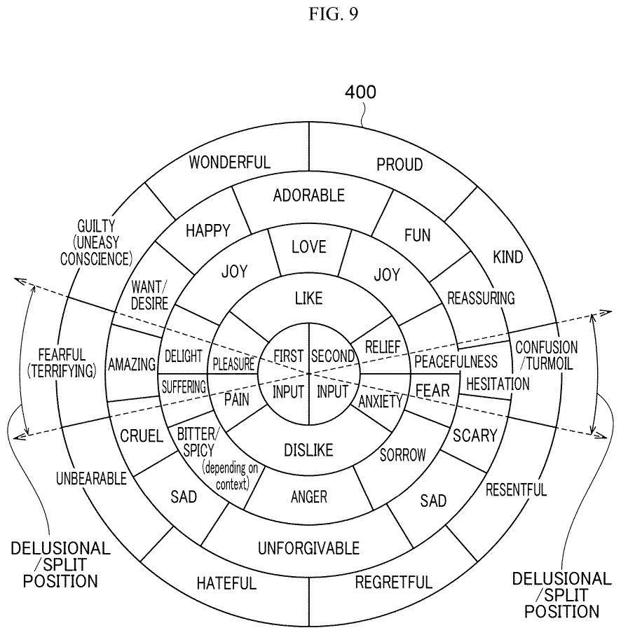

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

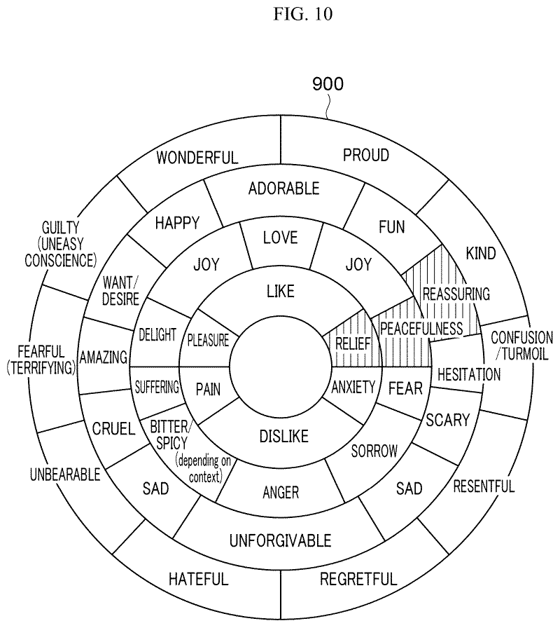

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a memory storing instructions,
wherein the processor is configured to execute the instructions to
receive user information from a user terminal via a communication path,
analyze the received user information by using a generative artificial intelligence model, and
classify the user information into processing units within an organization based on an analysis result,
analyze an emotional state of a user included in the received user information, and set a processing priority of the user information based on an emotion analysis result,
provide, to the user terminal, an operation screen that allows input of a work start time, a work end time, a break time period, and a remark, and perform declaration-based work status management based on work time information and break time information declared by the user,
calculate an actual work time based on the work time information and the break time information stored in a storage device, and aggregate an overtime total for each calendar unit,
compare the overtime total with a time threshold stored as setting information, and, when the overtime total exceeds the time threshold, issue a warning to the user or a manager by using an electronic communication function or a display function,
acquire free-description information input as the remark, and determine presence or absence of an intermediate absence behavior and presence or absence of an eating and drinking behavior by performing character-string analysis processing on the free-description information,
add classification information indicating the intermediate absence behavior or the eating and drinking behavior, determined by the character-string analysis processing, to a work status record, and improve accuracy of grasping a work status based on the classification information,
periodically aggregate the work status record and the overtime total, and output a manager display screen including an aggregation result and a history of the warnings, and
store the work status record, the aggregation result, and the history of the warnings in a data storage device with access control.

### (Supplementary 2)

The system according to supplementary 1,
wherein the processor is configured to, when it is determined that the overtime total exceeds the time threshold, store an event of issuing the warning as warning history and provide the warning history in a list format on the manager display screen.

### (Supplementary 3)

The system according to supplementary 1,
wherein the processor is configured to, when analyzing the free-description information input as the remark, automatically classify a break behavior including going out and a predetermined eating and drinking behavior by using a predefined set of expressions or a trained language model, correct the work status record based on a classification result, and grasp the work status of the user with increased accuracy.

### Application Example 1

### (Supplementary 1)

A system comprising a processor,
wherein the processor is configured to
receive information including identification information from a user;
analyze the received information by using a generative artificial intelligence means and classify the information into a division based on an analysis result;
analyze an emotional state of the user and set a priority of the information based on an emotional analysis result;
accept, based on a declaration by the user, input of a clock-in time, a clock-out time, and a break time, and record the input as attendance information in a storage device;
calculate, from the recorded attendance information, an overtime duration exceeding a reference working duration, and aggregate a total overtime duration for each user;
generate warning information in response to the total overtime duration exceeding a preset threshold duration, and transmit the warning information to an output device so that at least one of an audio warning and a display warning is presented to the user;
acquire, through a remark input from the user, information relating to a reason for a mid-shift absence and presence or absence of a meal, and record the information in association with the attendance information;
read identification information of the user from an identification medium via a reading device;
record, in real time, a work start time, a break start time, a break end time, and a work end time of the user in a time-information storage device by using the read identification information and time information obtained from a time source;
calculate an actual working duration by subtracting a total break duration from a working duration between the work start time and the work end time, and use the actual working duration for calculation of the overtime duration;
aggregate the attendance information, the overtime duration information, and the remark information and generate aggregated data for display to a supervisor;
automatically generate a prompt sentence for input to a generative artificial intelligence model based on the aggregated data including the attendance information and the overtime duration information, and transmit the prompt sentence together with the aggregated data to the generative artificial intelligence model via a communication interface; and
generate, based on an analysis result received from the generative artificial intelligence model, explanation information or improvement-proposal information for the user or the supervisor, and output the explanation information or the improvement-proposal information to a display device.

### (Supplementary 2)

The system according to supplementary 1,
wherein the processor is configured to generate, when the total overtime duration exceeds a predetermined duration, warning information and cause at least one of an audio output device and a display device to present a warning to a corresponding user.

### (Supplementary 3)

The system according to supplementary 1,
wherein the processor is configured to use the information relating to the reason for the mid-shift absence and the presence or absence of the meal, obtained through the remark input, to calculate an index relating to an actual working condition and a health condition for each user, and to provide the index to the generative artificial intelligence means for analysis so as to grasp the attendance status of the user in more detail and with higher accuracy.

### Example 2

### (Supplementary 1)

A system comprising a processor,
wherein the processor is configured to
receive work-related information from a user via a communication interface,
analyze the received work-related information by using a generative artificial intelligence model and classify the work-related information into internal handling functions based on an analysis result,
analyze an emotional state of the user and set a processing priority of the work-related information based on an emotional analysis result,
acquire working-time information, break-time information, and overtime information based on self-declaration by the user and perform attendance management on a declaration basis,
calculate actual working time by subtracting a break duration from a total duration between a working start time and a working end time included in the working-time information and the break-time information, and aggregate a total overtime duration in units of time based on the actual working time,
compare the aggregated total overtime duration with a predetermined reference duration and,
when the total overtime duration exceeds the predetermined reference duration, generate warning information and provide a notification of the warning information to the user,
store, as remark information, outing-reason information during working time and meal-presence information during a break, which are received from the user as a remark input associated with the working-time information and the break-time information,
analyze the remark information and classify the outing-reason information and the meal-presence information so as to determine whether a labor-related consideration state requiring attention has occurred,
generate manager-report information based on a determination result regarding the labor-related consideration state and the total overtime duration, and transmit the manager-report information to a manager via a notification medium, and
execute, by running a program on an information processing device, at least a part of declaration-based attendance management, overtime aggregation, warning notification,
remark analysis, and manager reporting by performing computation processing on attendance data stored in a data storage device.

### (Supplementary 2)

The system according to supplementary 1,
wherein the processor is configured to
generate the manager-report information by supplying a prompt sentence to the generative artificial intelligence model to request generation of an attendance-status summary, and
construct the manager-report information based on a response output from the generative artificial intelligence model.

### (Supplementary 3)

The system according to supplementary 1,
wherein the processor is configured to
supply a prompt sentence to the generative artificial intelligence model to request classification of the outing-reason information and the meal-presence information included in the remark information, receive a classification result from the generative artificial intelligence model, and grasp the attendance status of the user in greater detail based on the classification result.

### Application Example 2

### (Supplementary 1)

A system comprising a processor,
wherein the processor is configured to
receive activity information and attendance information from a user,
construct a prompt sentence for a generative AI model based on the received information and transmit the prompt sentence to the generative AI model for analysis,
classify the received information into a processing entity on a business unit basis or an organizational unit basis in accordance with an analysis result received from the generative AI model,
estimate an emotional state of the user based on input information and sensing information related to the user,
set a processing priority of the information or a management criterion for the user dynamically based on an emotional analysis result,
record attendance information based on self-reported data from the user,
calculate, based on the recorded attendance information, a total working time and a total overtime working time in a predetermined period,
determine whether the calculated total overtime working time exceeds a reference time and, when the reference time is exceeded, issue a warning to the user or a manager,
analyze remark information input by the user using a natural language processing function to extract an interruption reason, an external leaving status, and a meal status, and structure the extracted information as attendance information,
change the reference time for overtime working time or a warning condition based on the emotional state of the user,
acquire operation-state information and sensor information from a work apparatus or a machine apparatus,
calculate an operating time of the apparatus in a predetermined period based on the acquired operation-state information,
calculate, based on the acquired sensor information, a numerical index representing a load state or a stress state of the apparatus,
issue a warning to a management entity of the apparatus and, as necessary, adjust an operation schedule or an operation condition of the apparatus when the operating time exceeds a predetermined time or when the numerical index exceeds a predetermined threshold, and
generate a prompt sentence requesting the generative AI model to generate a design or an improvement proposal for an attendance management policy or an apparatus monitoring policy, and use a result generated by the generative AI model as setting information or as a template of a notification document.

### (Supplementary 2)

The system according to supplementary 1,
wherein the processor is configured to compare the calculated total overtime working time with the reference time that is dynamically set in accordance with the emotional state of the user, and, when the reference time is exceeded, transmit a high-priority warning through a plurality of communication means.

### (Supplementary 3)

The system according to supplementary 1,
wherein the processor is configured to detect an abnormal state for the work apparatus or the machine apparatus by combining the operating time and the stress state represented by the numerical index, and to provide, based on a detection result, an automatic proposal for a maintenance plan and a labor plan for both human resources and apparatus resources and to supply the detection result to the attendance management function and to the generative AI model.

What is claimed is:

1. A system comprising:
a communication interface coupled to a packet-switched network; and
circuitry configured to:
receive, via the communication interface, input data from a terminal device, the input data comprising text data and user identification information;
analyze the text data by executing a generative neural network model to generate structured analysis data comprising a category classification and a content summary;
classify the input data into a processing category based on the structured analysis data;
estimate an emotional state of the user from the text data by executing an emotion analysis algorithm, and assign a priority value to the input data based on the emotional state;
store the classified input data and the priority value in a storage device; and
transmit a notification comprising the priority value and the category classification to a destination device via the communication interface.

2. The system according to claim 1, wherein the circuitry is configured to receive, via the communication interface, time declaration data from the terminal device, the time declaration data comprising a start time, an end time, and a break duration, and compute an aggregate time metric for a calendar period based on the time declaration data.

3. The system according to claim 2, wherein the circuitry is configured to compare the aggregate time metric with at least one stored threshold value and, in response to determining that the aggregate time metric exceeds the threshold value, generate alert data and transmit the alert data to the terminal device via the communication interface.

4. The system according to claim 3, wherein the circuitry is configured to store alert history records in the storage device, each alert history record comprising a timestamp, the aggregate time metric, and the threshold value that was exceeded.

5. The system according to claim 4, wherein the circuitry is configured to receive free-text remark data from the terminal device and execute a string analysis operation on the remark data using at least one expression pattern set or a trained language model to detect behavioral indicators, and associate detected behavioral indicators with corresponding time records in the storage device.

6. The system according to claim 5, wherein the circuitry is configured to periodically aggregate classified input data, time records, alert history records, and behavioral indicator data into summary data formatted in a machine-readable structure, and transmit the summary data to an administrator terminal via the communication interface.

7. The system according to claim 1, wherein the emotion analysis algorithm comprises extracting sentiment features from the text data, computing a sentiment score, and mapping the sentiment score to the priority value using a predefined mapping function stored in the storage device.

8. The system according to claim 7, wherein the circuitry is configured to maintain an interaction history in the storage device comprising prior input data, corresponding structured analysis data, and assigned priority values, and incorporate at least a portion of the interaction history into a subsequent analysis operation.

9. The system according to claim 8, wherein the generative neural network model comprises a transformer architecture having a plurality of self-attention layers, and the circuitry is configured to set inference parameters comprising at least a temperature value and a maximum output token count prior to inputting the text data.

10. The system according to claim 9, wherein the circuitry is configured to generate a prompt sentence comprising the text data and context data derived from the interaction history, the prompt sentence being formatted with a classification instruction field and an output format constraint field, and input the prompt sentence to the generative neural network model.

11. The system according to claim 1, wherein the category classification is determined by the generative neural network model outputting a probability distribution over a plurality of predefined categories, and the circuitry selects a category having a highest probability value.

12. The system according to claim 11, wherein the circuitry is configured to apply a confidence threshold to the probability distribution and, when no category exceeds the confidence threshold, route the input data to a default processing queue and flag the input data for manual review.

13. The system according to claim 12, wherein the circuitry is configured to detect an anomaly in the structured analysis data by computing a consistency score between the category classification and keyword data extracted from the text data, and trigger re-analysis when the consistency score falls below a threshold value.

14. The system according to claim 13, wherein the re-analysis comprises modifying the prompt sentence to include an indication of the detected inconsistency and retransmitting the modified prompt sentence to the generative neural network model.

15. The system according to claim 1, wherein the circuitry is configured to execute a natural language processing operation on the text data comprising tokenization, named entity recognition, and dependency parsing to extract structured entity data prior to generating the prompt sentence.

16. The system according to claim 1, wherein the circuitry is configured to compute, based on stored time records and alert history, a trend metric indicating a rate of change of the aggregate time metric over successive calendar periods, and include the trend metric in the summary data.

17. The system according to claim 1, wherein the input data further comprises at least one of:
image data captured by the terminal device, audio data converted to text by a speech recognition process, and structured form data comprising predefined field values.

18. A system comprising:
a communication interface coupled to a packet-switched network; and
circuitry configured to:
receive, via the communication interface, input data from a terminal device comprising text data and user identification information;
generate a prompt sentence comprising the text data and context data, the prompt sentence being formatted with a classification instruction field and an output format constraint field;
input the prompt sentence to a generative neural network model comprising a transformer architecture to generate structured analysis data comprising a category classification, a content summary, and a priority recommendation;
estimate an emotional state of the user by executing an emotion analysis algorithm on the text data and assign a priority value based on the emotional state;
receive time declaration data from the terminal device, compute aggregate time metrics, compare the aggregate time metrics with stored threshold values, and generate alert data when a threshold is exceeded;
execute a string analysis operation on free-text remark data to detect behavioral indicators and associate the behavioral indicators with time records;
detect an anomaly in the structured analysis data and trigger re-analysis when a consistency score falls below a threshold; and
transmit classified data, alert data, and summary data to destination devices via the communication interface.

19. The system according to claim 18, wherein the circuitry is configured to train the emotion analysis algorithm using a training dataset comprising text samples paired with emotion labels, the training applying a cross-entropy loss function and updating model parameters using a gradient-based optimization algorithm.

20. A method comprising:
receiving, via a communication interface coupled to a packet-switched network, input data from a terminal device, the input data comprising text data and user identification information;
analyzing the text data by executing a generative neural network model to generate structured analysis data comprising a category classification and a content summary;
classifying the input data into a processing category based on the structured analysis data;
estimating an emotional state of the user from the text data by executing an emotion analysis algorithm, and assigning a priority value to the input data based on the emotional state;
storing the classified input data and the priority value in a storage device; and
transmitting a notification comprising the priority value and the category classification to a destination device via the communication interface.
